(19) United States
(12) Patent Application Publication
(10) Pub. No.: US 2025/0319806 A1
(43) Pub. Date: Oct. 16, 2025

(54) VEHICLE CUP HOLDER

(71) Applicant: TOYODA GOSEI CO., LTD., Kiyosu-shi (JP)

(72) Inventors: Masatoshi HAMADA, Kiyosu-shi (JP); Takuji SHIRAI, Kiyosu-shi (JP); Yasushi HIBINO, Kiyosu-shi (JP); Minoru SHIBATA, Kiyosu-shi (JP); Mineo FUKUI, Kiyosu-shi (JP); Naoaki ITO, Kiyosu-shi (JP)

(21) Appl. No.: 19/095,933

(22) Filed: Mar. 31, 2025

(30) Foreign Application Priority Data
Apr. 10, 2024 (JP) 2024-063474
Sep. 13, 2024 (JP) 2024-159089

(51) Int. Cl. B60N 3/10

(52) U.S. Cl. CPC B60N 3/104

(57) ABSTRACT

A vehicle cup holder includes an accommodation portion including an upper end that has an opening. The accommodation portion is configured to accommodate at least a lower part of a beverage container. The accommodation portion includes a mounting portion configured such that the beverage container is placed on the mounting portion and a tubular side wall that surrounds the beverage container when the beverage container is placed on the mounting portion. A position of the mounting portion in a vertical direction is adjustable. A side heat insulator is arranged at least at a portion of the side wall that is higher than the mounting portion when the mounting portion is located at a lowest point. The side heat insulator limits transfer of heat in a thickness direction of the side wall.

### CROSS-REFERENCE TO RELATED APPLICATIONS

This application is based upon and claims the benefit of priority from Japanese Patent Application No. 2024-063474, filed on Apr. 10, 2024, and Japanese Patent Application No. 2024-159089, filed on Sep. 13, 2024, the entire contents of each of which are incorporated herein by reference.

### BACKGROUND

### 1. Field

The present disclosure relates to a vehicle cup holder configured to be installed in the passenger compartment of a vehicle and hold a beverage container.

### 2. Description of Related Art

Japanese Laid-Open Patent Publication No. 2003-165370 discloses an example of a vehicle cup holder configured to be installed in the passenger compartment of a vehicle and hold a beverage container such as a beverage can, a plastic bottle, or a paper cup. The exemplary vehicle cup holder includes an accommodation portion that has an opening at its upper end. The accommodation portion is configured to accommodate at least the lower part of a beverage container. The accommodation portion includes a mounting portion on which a beverage container is placed and a tubular side wall that extends vertically. When the beverage container is placed on the mounting portion, the tubular side wall surrounds the beverage container.

To use the vehicle cup holder, the beverage container is inserted into the accommodation portion through the opening and placed on the mounting portion. The beverage container is positioned such that at least its lower part is accommodated in the accommodation portion.

In the vehicle cup holder disclosed in the above-described publication, the mounting portion is configured to move up and down. The depth of the mounting portion from the upper surface of the vehicle cup holder is adjustable according to the height of the beverage container. This allows a high-profile beverage container to be stably accommodated and also allows a low-profile beverage container to be readily removed from the accommodation portion.

Further, the vehicle cup holder includes a passage that directs warm or cool air into the accommodation portion. The side wall includes an inlet for the warm or cool air. Accordingly, warm or cool air is directed into the accommodation portion through the passage and the inlet so that the air strikes the beverage container. Thus, temperature changes in the beverage container and the beverage are limited (i.e., the beverage container and the beverage are kept warm or cool) for a relatively long period.

However, the vehicle cup holder disclosed in the above-described publication needs to include a passage that directs warm or cool air into the inlet of the side wall to keep the beverage container warm or cool. As a result, the vehicle cup holder will have a complicated structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a vehicle cup holder configured to be arranged in a passenger compartment of a vehicle and hold a beverage container. The vehicle cup holder includes an accommodation portion including an upper end that has an opening. The accommodation portion is configured to accommodate at least a lower part of the beverage container. The accommodation portion includes a mounting portion configured such that the beverage container is placed on the mounting portion and a tubular side wall extending in a vertical direction. The side wall surrounds the beverage container when the beverage container is placed on the mounting portion. A position of the mounting portion in the vertical direction is adjustable. A side heat insulator is arranged at least at a portion of the side wall that is higher than the mounting portion when the mounting portion is located at a lowest point. The side heat insulator limits transfer of heat in a thickness direction of the side wall.

Other features and aspects will be apparent from the following detailed description, the drawings, and the claims.

### BRIEF DESCRIPTION OF THE DRAWINGS

FIG. 1 is a vertical cross-sectional view of a vehicle cup holder according to a first embodiment that holds a low-profile beverage container.

FIG. 2 is a front view of the vehicle cup holder shown in FIG. 1.

FIG. 3 is an enlarged view of section A shown in FIG. 1.

FIG. 4 is an enlarged view of section B shown in FIG. 1.

FIG. 5 is an enlarged view of section C shown in FIG. 1.

FIG. 6 is a block diagram illustrating the electrical configuration of the vehicle cup holder in the first embodiment.

FIG. 7 is a flowchart illustrating the lift control routine executed by the controller in the first embodiment.

FIG. 8 is a flowchart illustrating the indicator control routine executed by the controller in the first embodiment.

FIG. 9 is a partial vertical cross-sectional view illustrating the operation of the lift mechanism in the first embodiment.

FIG. 10 is a partial vertical cross-sectional view of the vehicle cup holder in the first embodiment, with the lowered bottom on which a high-profile beverage container is placed.

FIG. 11 is a vertical cross-sectional view of the vehicle cup holder according to a second embodiment, with the bottom (mounting portion) lowered.

FIG. 12 is an enlarged view of section E shown in FIG. 11.

FIG. 13 is a vertical cross-sectional view of the vehicle cup holder of the second embodiment, with the bottom (mounting portion) lifted.

FIG. 14 is a vertical cross-sectional view of a third embodiment, illustrating the relationship between the accommodation portion of the vehicle cup holder and a spacer prior to being arranged in the side wall of the accommodation portion.

FIG. 15 is a vertical cross-sectional view of the vehicle cup holder of the third embodiment that holds the low-profile beverage container in a state in which the spacer is arranged in a first orientation within the side wall.

FIG. 16 is a vertical cross-sectional view of the vehicle cup holder of the third embodiment that holds the high-profile beverage container in a state in which the spacer is arranged in a second orientation within the side wall.

FIG. 17 is an enlarged view of section F shown in FIG. 14.

FIG. 18 is a partial vertical cross-sectional view illustrating how a plastic bottle is detected as the beverage container by the container detection sensor in the first embodiment.

FIG. 19 is a partial cross-sectional view illustrating the vehicle cup holder according to a modification in which a container detection sensor of a type different from that in the first embodiment is used along with the beverage container.

FIG. 20 is a partial vertical cross-sectional view of the vehicle cup holder according to a modification in which a heater for reheating the beverage container and beverage is arranged on the inner surface of the side wall.

FIG. 21 is a diagram of a modification, illustrating the arrangement of the container detection sensors and the temperature sensor.

FIG. 22 is a partial vertical cross-sectional view of the vehicle cup holder according to a modification in which the raising of the lowered bottom is stopped at a time when the upper surface of the beverage container is slightly exposed from the upper surface of the vehicle cup holder.

FIG. 23 is a partial vertical cross-sectional view illustrating a modification of the side heat insulator, corresponding to FIG. 17.

FIG. 24 is a partial vertical cross-sectional view illustrating another modification of the side heat-insulating portion, corresponding to FIG. 17.

FIG. 25 is a vertical cross-sectional view illustrating a modification of the spacer in the third embodiment.

FIG. 26 is a vertical cross-sectional view illustrating another modification of the spacer in the third embodiment.

FIG. 27 is a vertical cross-sectional view illustrating a further modification of the spacer in the third embodiment.

FIG. 28 is a vertical cross-sectional view illustrating a modification of the spacer in the third embodiment in which the vertical position of the mounting portion is changed.

FIG. 29 is a partial vertical cross-sectional view of the vehicle cup holder according to a modification that holds the low-profile beverage container in a state in which the spacer of FIG. 28 is arranged in the first orientation within the side wall.

FIG. 30 is a partial vertical cross-sectional view of the vehicle cup holder according to a modification that holds the high-profile beverage container in a state in which the spacer of FIG. 28 is arranged in the second orientation within the side wall.

FIG. 31 is a vertical cross-sectional view illustrating a modification of the vehicle cup holder that uses an auxiliary spacer in addition to the spacer.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

The term “annular” as used in this description may refer to any structure that forms a loop, or a continuous shape with no ends. “Annular” shapes include but are not limited to a circular shape, an elliptic shape, and a polygonal shape with sharp or rounded corners.

### First Embodiment

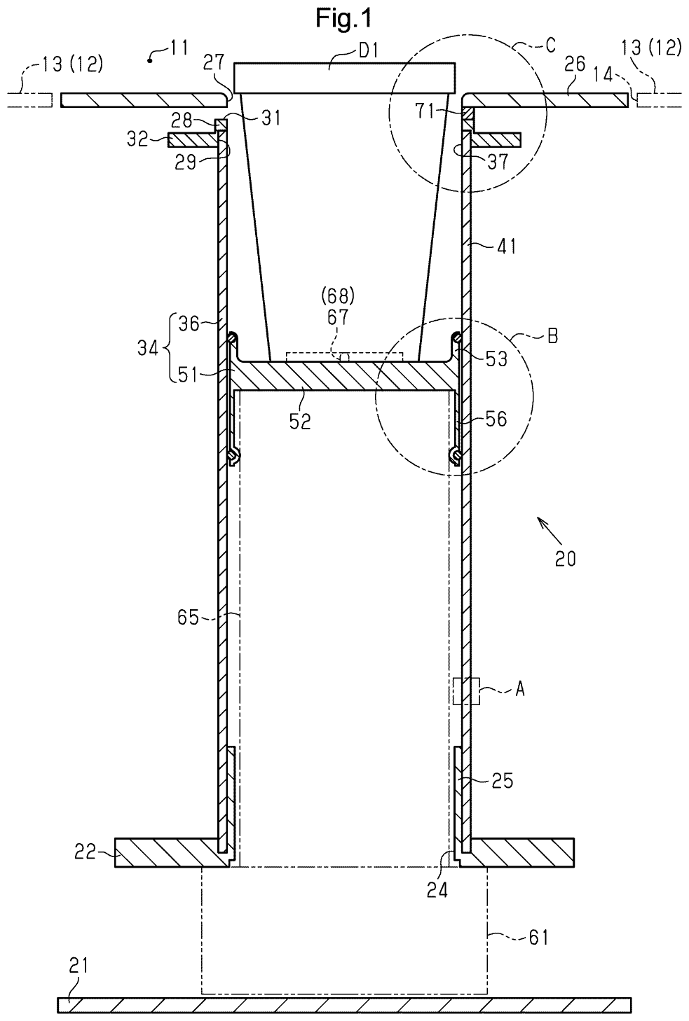

A vehicle cup holder 20 (hereinafter simply referred to as the cup holder 20) according to a first embodiment will now be described with reference to FIGS. 1 to 10.

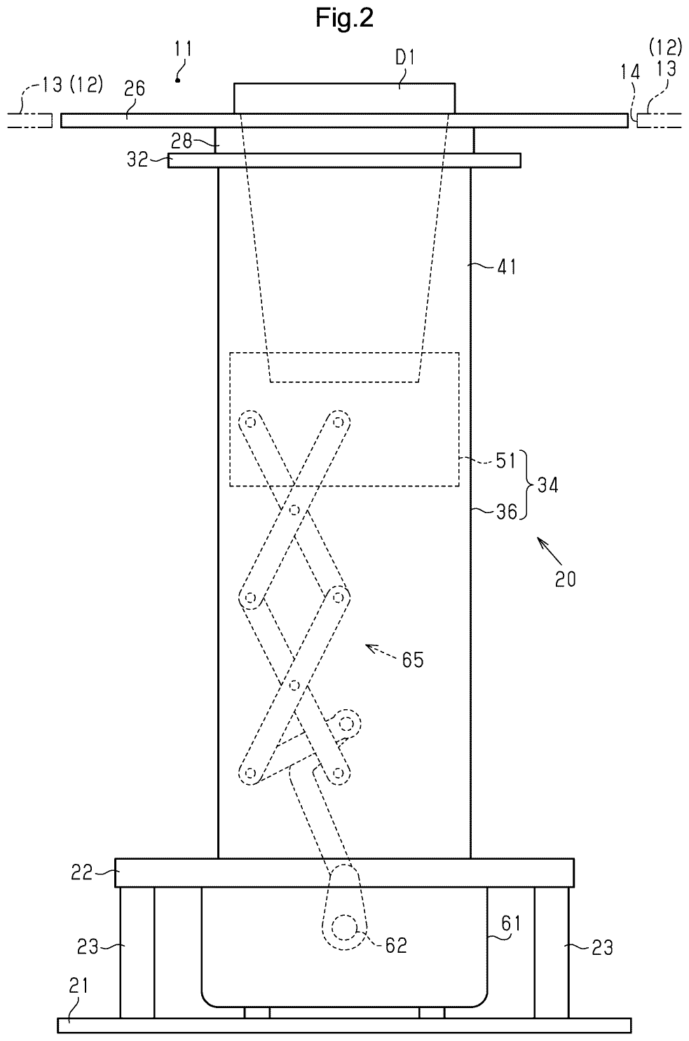

As shown in FIGS. 1 and 10, the cup holder 20 is used to hold a beverage container D1 or D2 in a passenger compartment 11 of a vehicle, and may be referred to as a drink holder. In this case, the beverage container held by the cup holder 20 includes a low-profile beverage container D1 or a high-profile beverage container D2, which is taller than the beverage container D1. Examples of the beverage container D1 include a lidded cup as shown in FIGS. 1 and 2, and a beverage can as shown in FIG. 20. Examples of the beverage container D2 include a plastic bottle as shown in FIG. 10, and the beverage can as shown in FIG. 20.

As shown in FIG. 1, the cup holder 20 is installed in the passenger compartment 11. This installation may be performed by integrating the cup holder 20 into an interior component 12 (e.g., a console box) of the passenger compartment 11. Alternatively, the installation may be performed by independently attaching the cup holder 20 in the passenger compartment 11. When the cup holder 20 is incorporated into the interior component 12, an opening 14 is formed in an upper wall 13 of the interior component 12.

As shown in FIGS. 1 and 2, the lower part of the cup holder 20 includes a lower base 21, an upper base 22, and pillars 23. The upper base 22 is located at a position separated upward from the lower base 21. The pillars 23 extend in the vertical direction between the lower base 21 and the upper base 22 to couple the lower base 21 to the upper base 22.

The upper base 22 has an opening 24. The upper base 22 includes a cylindrical lower attachment 25 that protrudes upward from a peripheral edge of the opening 24.

As shown in FIGS. 1, 2, and 5, the upper part of the cup holder 20 includes a top plate 26, a tubular portion 28, and a flange 32. The top plate 26 is flat, and is located in the opening 14 of the upper wall 13. The upper surface of the top plate 26 defines the upper surface of the cup holder 20. The top plate 26 includes a circular opening 27 above the opening 24. The inner diameter of the opening 27 is set to the same as or almost the same as the outer diameter of the lower attachment 25. The opening 27 is sized so as to allow insertion of the beverage container D1 or D2 in the vertical direction.

The tubular portion 28 is shaped as a low-profile cylindrical portion, and protrudes downward from a peripheral edge of the opening 27 of the top plate 26. The inner diameter of the tubular portion 28 remains the same at any position of the tubular portion 28 in the vertical direction, and is set to the same as or almost the same as the inner diameter of the opening 27.

The flange 32 is formed in an annular shape and located on the outer circumference of the lower end of the tubular portion 28. The flange 32 is separated downward from the top plate 26 by a predetermined distance, and is arranged parallel or nearly parallel to the top plate 26.

The inner circumferential portion of the tubular portion 28 has an upper attachment 29. The upper attachment 29 is formed by an annular recess that extends upward from the lower surface of the tubular portion 28.

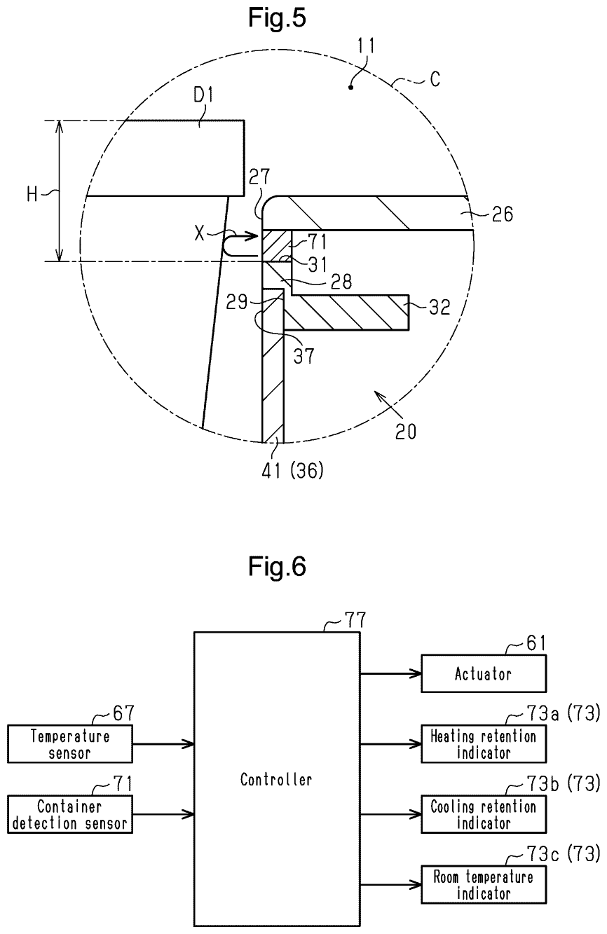

As shown in FIGS. 1 and 5, the upper end of the cup holder 20 has an accommodation portion 34 with an opening. The accommodation portion 34 includes a side wall 36 and a bottom 51. The accommodation portion 34 accommodates at least the lower part of the beverage container D1 or D2 through the opening.

### Side Wall 36

The side wall 36 extends in the vertical direction, and has the form of a cylinder with both the upper and lower ends open. The upper end of the side wall 36 has an opening 37, defining the opening of the accommodation portion 34. The opening 27 of the top plate 26, the tubular portion 28, and the opening 37 of the side wall 36 serve as the entrance of the beverage container D1 or D2.

The lower part of the side wall 36 is attached to the upper base 22 in a removable manner by being placed over the lower attachment 25 from above. The upper end portion of the side wall 36 is attached to the tubular portion 28 in a removable manner by being fitted into the upper attachment 29 from below.

The inner diameter of the side wall 36 is set to the same as or almost the same as the inner diameter of the opening 27 of the top plate 26 at any position of the side wall 36 in the vertical direction. Such setting allows the side wall 36 to surround the beverage container D1 or D2 that is placed on a mounting portion 52, which will be described later.

### Bottom 51

As shown in FIGS. 1 and 4, the bottom 51 includes the mounting portion 52, an upper protrusion 53, an upper seal member 55, a lower protrusion 56, and a lower seal member 58. The mounting portion 52 is where the beverage container D1 or D2 is placed, and has a circular shape. The upper protrusion 53 is annular, and extends upward from a peripheral edge of the mounting portion 52. The majority of the outer diameter of the upper protrusion 53 is set to be the same as or nearly the same as the outer diameter of the mounting portion 52.

The upper protrusion 53 has an upper annular recess 54 at its upper end portion. The upper annular recess 54 opens on the outer circumferential surface of the upper protrusion 53, and has a semi-circular cross-sectional shape. The upper seal member 55 is an O-ring formed from an elastic material, such as silicone rubber. The upper seal member 55 is attached to the outer circumference of the upper end portion of the upper protrusion 53 by fitting the inner circumferential portion of the upper seal member 55 into the upper annular recess 54.

The lower protrusion 56 is annular, and extends downward from the peripheral edge of the mounting portion 52. The majority of the outer diameter of the lower protrusion 56 is set to be the same as or nearly the same as the outer diameter of the mounting portion 52. The lower protrusion 56 has a lower annular recess 57 at its lower end portion. The lower annular recess 57 opens on the outer circumferential surface of the lower protrusion 56, and has a semi-circular cross-sectional shape. The lower seal member 58 is an O-ring formed from an elastic material such as silicone rubber. The lower seal member 58 is attached to the outer circumference of the lower end portion of the lower protrusion 56 by fitting the inner circumferential portion of the lower seal member 58 into the lower annular recess 57.

In a state in which the bottom 51 is inserted into the side wall 36, the upper seal member 55 and the lower seal member 58 are in tight contact with the inner surface of the side wall 36. The upper seal member 55 seals between the upper protrusion 53 and the side wall 36. The lower seal member 58 seals between the lower protrusion 56 and the side wall 36.

The outer diameter of the bottom 51, specifically, the outer diameter of the mounting portion 52, the outer diameter of the upper protrusion 53, and the outer diameter of the lower protrusion 56, are each set to be slightly smaller than the inner diameter of the side wall 36. The bottom 51 is inserted into the side wall 36 so as to be removable from the open parts of the upper and lower ends of the side wall 36.

As shown in FIGS. 1 and 10, the side wall 36 includes a side heat insulator 41. The side heat insulator 41 is located at least at a portion that is higher than the mounting portion 52 when the mounting portion 52 is located at its lowest point (see FIG. 10). In the first embodiment, the side heat insulator 41 is provided across the entire side wall 36 in the vertical direction.

### Side Heat Insulator 41

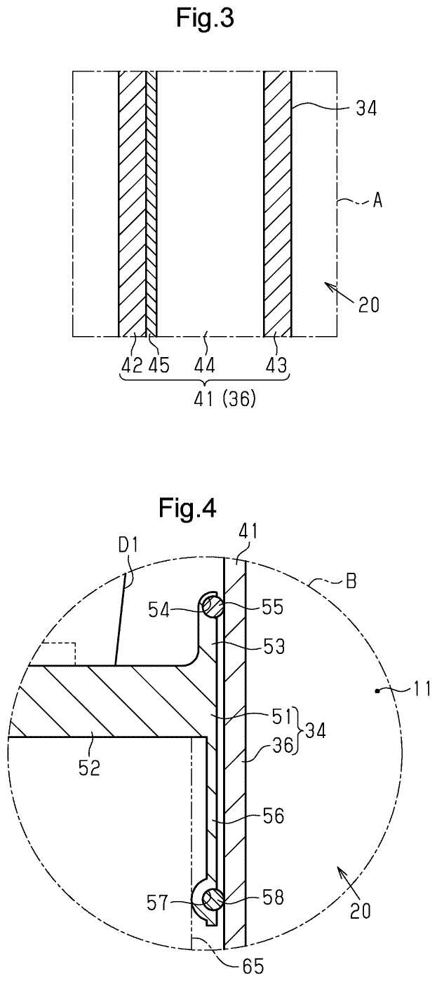

As shown in FIG. 3, the side heat insulator 41 includes multiple layers laminated in the thickness direction (lateral direction in FIG. 3) of the side wall 36, and has a layered structure that limits the transfer of heat in the thickness direction.

The layered structure includes an inner layer 42, an outer layer 43, a vacuum layer 44, and a metal foil layer 45. The inner layer 42 is located at the innermost part of the side heat insulator 41 in the thickness direction (left side in FIG. 3). The outer layer 43 is located a certain distance outward in the thickness direction from the inner layer 42 (right side in FIG. 3), and is located at the outermost part of the side heat insulator 41 in the thickness direction. The inner layer 42 and the outer layer 43 are formed from metal, such as stainless steel. The vacuum layer 44 is formed between the inner layer 42 and the outer layer 43. The metal foil layer 45 is located between the inner layer 42 and the outer layer 43. In the first embodiment, the metal foil layer 45 is laminated on the outer surface of the inner layer 42 in the thickness direction. The metal foil layer 45 is formed from metal foil, such as copper and aluminum.

As shown in FIGS. 1 and 2, the position of the bottom 51, which includes the mounting portion 52, is adjustable in the vertical direction. The position of the bottom 51 (mounting portion 52) in the vertical direction is adjusted by raising and lowering the bottom 51 (mounting portion 52) in the side wall 36. The bottom 51 (mounting portion 52) with its position adjusted in the vertical direction is configured to be held at multiple heights in the vertical direction. To raise, lower, and hold the bottom 51, an actuator 61 and a lift mechanism 65 are provided.

### Actuator 61

The actuator 61 is used to apply force in the vertical direction to the lift mechanism 65, so that the lift mechanism 65 operates. The actuator 61 is a rotary actuator that utilizes rotational motion. The actuator 61 includes a rotary shaft 62 that varies the rotation angle of the rotary shaft 62. Particularly, in the first embodiment, the actuator 61 allows the rotary shaft 62 to rotate in both forward and reverse directions.

### Lift Mechanism 65

The lift mechanism 65 includes a pantograph-type link mechanism that couples the bottom 51 (mounting portion 52) to the rotary shaft 62 of the actuator 61. The rotation of the rotary shaft 62 is transmitted to the lift mechanism 65, causing the lift mechanism 65 to extend and contract. This movement causes the bottom 51 to move up and down between a preset lowest position and a preset highest position while maintaining the mounting portion 52 in a horizontal position. As shown in FIG. 10, the lowest position is set at a depth greater than or equal to the height of the beverage container D2 from the position of the lower end of a container detection sensor 71, which will be described later (see FIG. 5). The highest position is set at a depth from the position of the lower end of the container detection sensor 71 by a value obtained by subtracting a constant height H (e.g., 20 mm) from the height of the beverage container D1. The highest position ensures that the low-profile beverage container D1 has its upper end exposed above the upper surface of the cup holder 20 (top plate 26) to a degree that allows the upper end to be pinched and lifted by fingers.

As shown in FIG. 1 and FIG. 6, the cup holder 20 includes a temperature sensor 67 and the container detection sensor 71 to detect the status of each component.

### Temperature Sensor 67

The temperature sensor 67 is used to detect the temperature of the beverage container D1 or D2 placed on the mounting portion 52. In the first embodiment, the temperature sensor 67 is a negative temperature coefficient (NTC) thermistor that has the characteristic of decreasing resistance as temperature increases. The temperature sensor 67 includes a detector 68 that detects temperature and an elastic member (not shown), such as a spring, that biases the detector 68 upward. The temperature sensor 67 is incorporated in the mounting portion 52. The detector 68 is pressed by the elastic member against the bottom surface of the beverage container D1 or D2 on the mounting portion 52 to detect the temperature of the beverage container D1 or D2.

### Container Detection Sensor 71

As shown in FIG. 5, the container detection sensor 71 is arranged between the side wall 36 and the top plate 26 to detect the beverage container D1 or D2. Specifically, part of the tubular portion 28 includes a connection portion 31 that extends in the thickness direction of the side wall 36 to connect the interior and exterior of the tubular portion 28.

In the first embodiment, the container detection sensor 71 is a reflective infrared (IR) sensor with a built-in light-emitting element and light-receiving element. The container detection sensor 71 is arranged in the connection portion 31 with the light-emitting element and light-receiving element directed inward of the tubular portion 28 in the thickness direction. With this arrangement, the container detection sensor 71 is adjacent to the lower side of the top plate 26. The light-emitting element converts electrical signals into optical signals. Examples of light-emitting devices include semiconductor lasers and light-emitting diodes (LEDs). In this example, the light-emitting element is an infrared LED, which is a light-emitting diode that emits infrared light. When the beverage container D1 or D2 is accommodated in the accommodation portion 34, the infrared light emitted by the light-emitting element is reflected on the front surface of the beverage container D1 or D2 as shown by arrow X in FIG. 5.

The light-receiving element converts optical signals into electrical signals, and may be, for example, a photodiode or a phototransistor. The container detection sensor 71 detects the beverage container D1 or D2 based on the amount (intensity) of infrared light received by the light-receiving element.

As shown in FIG. 6, the cup holder 20 includes indicators 73, each emitting light of a different color.

### Indicators 73

The indicators 73 include a heating retention indicator 73a, a cooling retention indicator 73b, and a room temperature indicator 73c, each including a single-color LED. The heating retention indicator 73a emits light of a warm color (e.g., yellow) that reminds the occupant that the beverage container D1 or D2 is warm. The cooling retention indicator 73b emits light of a cool color (e.g., blue) that reminds the occupant that the beverage container D1 or D2 is cold. The room temperature indicator 73c emits light of a color (e.g., white) that reminds the occupant that the beverage container D1 or D2 is neither warm nor cold. If the heating retention indicator 73a, the cooling retention indicator 73b, and the room temperature indicator 73c do not have to be distinguished from each other, they may simply be referred to as the indicator 73.

### Controller 77

The cup holder 20 includes a controller 77. The controller 77 controls the operation of the actuator 61 based on the detection result of the container detection sensor 71. The controller 77 also controls the operation of the indicator 73 based on the detection results of both the temperature sensor 67 and the container detection sensor 71. The controller 77 may be circuitry including: 1) one or more processors that operate according to a computer program (software); 2) one or more dedicated hardware circuits such as application-specific integrated circuits (ASICs) that execute at least part of various processes; or 3) a combination thereof. The processor includes a CPU and a memory such as a RAM and a ROM. The memory stores program codes or commands configured to cause the CPU to execute processes. The memory, or a computer-readable medium, includes any type of media that are accessible by general-purpose computers and dedicated computers. The controller 77 may be exclusively provided for the cup holder 20, or may be shared with the electronic control unit (ECU) installed in the vehicle.

### Operation of the First Embodiment

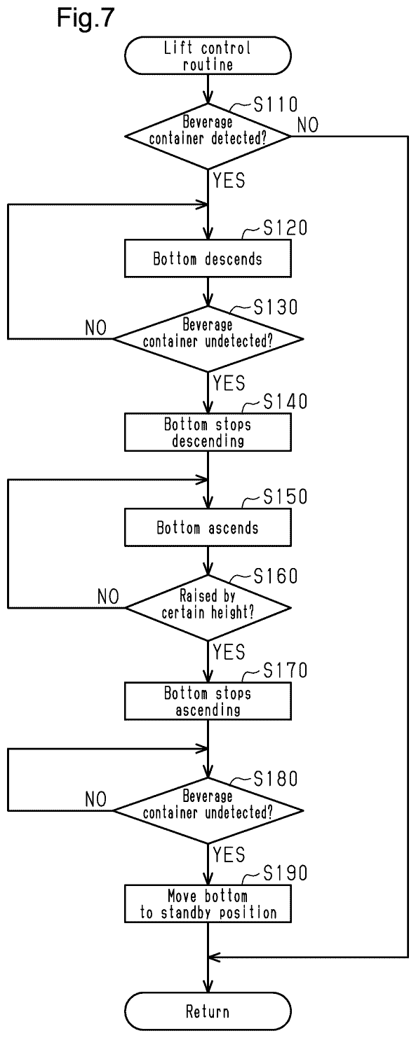

The flowchart in FIG. 7 illustrates a lift control routine executed by the controller 77. Before the lift control routine is initiated, the bottom 51 is stationary (on standby) at a predetermined position (hereinafter referred to as the standby position).

Upon starting the lift control routine, the controller 77 first determines in step S110 that the beverage container D1 or D2 has been detected by the container detection sensor 71. If the beverage container D1 or D2 is placed on the mounting portion 52 of the bottom 51 that is stationary at the standby position, the beverage container D1 or D2 is detected by the container detection sensor 71. When the determination condition of step S110 is satisfied, the rotary shaft 62 of the actuator 61 is rotated in a predetermined direction in step S120. The rotation causes the lift mechanism 65 to contract, thereby lowering the bottom 51 while maintaining the mounting portion 52 in a horizontal position.

Then, in step S130, the controller 77 determines that the beverage container D1 or D2 has no longer been detected by the container detection sensor 71. If the beverage container D1 or D2 is lowered to a position that is lower than that of the lower end of the container detection sensor 71, the beverage container D1 or D2 will no longer be detected by the container detection sensor 71. When the determination condition of step S130 is not satisfied, the process returns to step S120. As a result, the bottom 51 continues to be lowered.

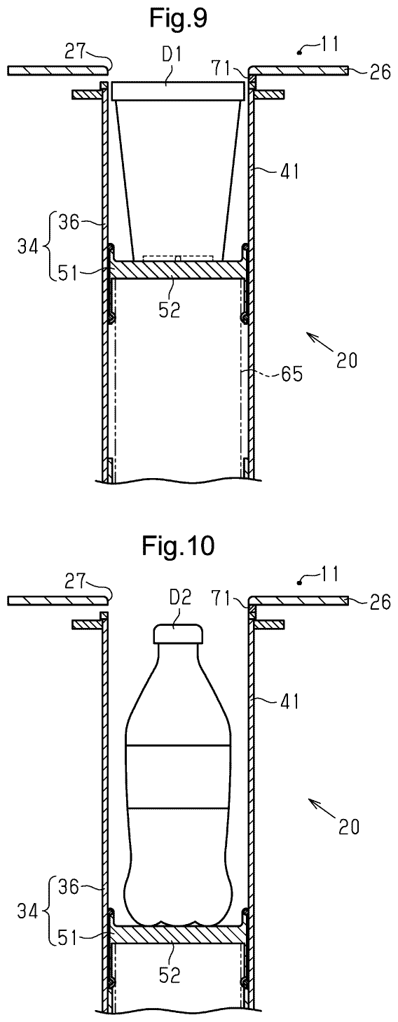

When the determination condition of step S130 is satisfied, the controller 77 proceeds to step S140. In step S140, the rotation of the rotary shaft 62 of the actuator 61 is stopped. This causes the lift mechanism 65 to stop contracting, so that the lowering of the bottom 51 is stopped. In this step, as shown in FIG. 9, the upper surface of the beverage container D1 or D2 is located at the same vertical position as that of the lower end of the container detection sensor 71 or located at a position that is slightly lower than that vertical position. Depending on the height of the beverage container D1 or D2, the duration during which the bottom 51 is lowered by the process of the above-described step S120 differs. The longer the beverage container D1 or D2, the longer the duration. As a result, the bottom 51 descends to a deeper position.

Next, in step S150 of FIG. 7, the rotary shaft 62 of the actuator 61 is rotated in the direction opposite to that in step S120. The rotation causes the lift mechanism 65 to extend, thereby raising the bottom 51 while maintaining the mounting portion 52 in a horizontal position.

Then, in step S160, after the vertical movement of the bottom 51 switches from downward to upward, the controller 77 determines whether the bottom 51 has risen by the constant height H (H=20 mm) as shown in FIG. 5. In this case, the rotation amount (angle) of the rotary shaft 62 to raise the bottom 51 by 20 mm is predetermined. The controller 77 determines whether the rotary shaft 62 has rotated by the rotation amount (angle). When the determination condition in step S160 of FIG. 7 is not satisfied, the process returns to step S150. As a result, the bottom 51 rises until the determination condition of step S160 is satisfied.

When the determination condition of step S160 is satisfied (i.e., the bottom 51 rises by the constant height H), the rotation of the rotary shaft 62 of the actuator 61 is stopped in step S170. As shown in FIGS. 1 and 5, this causes the lift mechanism 65 to stop extending, so that the raising of the bottom 51 is stopped. Regardless of the height of the beverage container D1 or D2, the duration during which the bottom 51 rises in the process of the above-described step S150 remains the same. The upper surface of the beverage container D1 or D2 is located at a position separated upward from the lower end of the container detection sensor 71 by the constant height H (20 mm in this case). The upper end portion (including the upper surface) of the beverage container D1 or D2 is exposed upward from the cup holder 20 (top plate 26). This allows a user to readily remove the beverage container D1 or D2 from the accommodation portion 34 by pinching the exposed part of the top plate 26 of the beverage container D1 or D2 with the fingers and lifting the exposed part.

Subsequently, in step S180, the controller 77 determines whether the beverage container D1 or D2 has been no longer detected by the container detection sensor 71. If the beverage container D1 or D2 is removed from the accommodation portion 34, the beverage container D1 or D2 will no longer be detected by the container detection sensor 71. When the determination condition of step S180 is not satisfied, the controller 77 repeats the process of step S180.

When the determination condition of step S180 is satisfied, the rotary shaft 62 of the actuator 61 is rotated in step S190 in the same direction as that in step S120. The rotation causes the lift mechanism 65 to contract, thereby moving the bottom 51 to the standby position. The standby position is, for example, higher than the vertical position of the mounting portion 52 when the bottom 51 on which the high-profile beverage container D2 is placed stops descending in step S140. Further, the standby position is lower than the vertical position of the mounting portion 52 when the bottom 51 on which the low-profile beverage container D1 is placed stops ascending in step S170.

After executing the process in step S190, the controller 77 suspends the lift control routine. When the determination condition of step S110 is not satisfied (i.e., when the beverage container D1 or D2 is not detected by the container detection sensor 71), the controller 77 suspends the lift control routine without executing the processes of the above-described steps S120 to step S190.

In the lift control routine, the bottom 51 is raised and lowered to change the depth of the mounting portion 52 on which the beverage container D1 or D2 is placed from the upper surface of the top plate 26 (steps S120, S150, and S190).

Further, even if a beverage container D1 or D2 with any height is placed on the mounting portion 52, the upper end portion of the beverage container D1 or D2 is exposed from the upper surface of the cup holder 20 (top plate 26) by the same height (steps S150 to S170). The majority of the beverage container D1 or D2 excluding the upper end portion is accommodated in the accommodation portion 34. Thus, either the high-profile beverage container D2 or the low-profile beverage container D1 is stably accommodated in the accommodation portion 34.

The upper end portion of the beverage container D1 or D2 that is exposed upward from the upper surface of the cup holder 20 (top plate 26) serves as a grip part (grip area). In other words, regardless of the height, the beverage container D1 or D2 is held at a vertical position that allows the container to be readily removed from the cup holder 20.

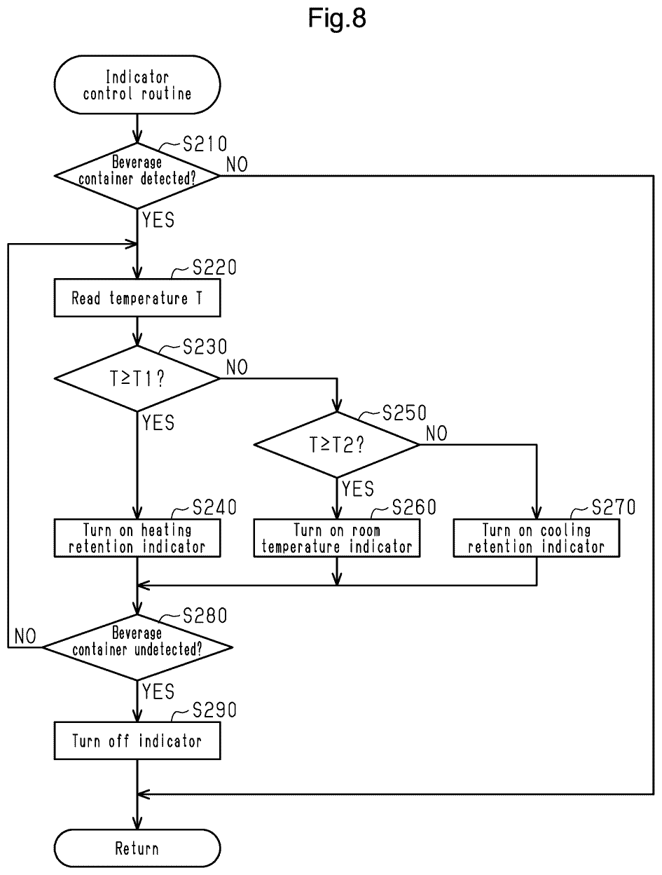

The flowchart in FIG. 8 illustrates an indicator control routine executed by the controller 77.

Upon starting the indicator control routine, the controller 77 first determines in step S210 that the beverage container D1 or D2 has been detected by the container detection sensor 71.

When the determination condition of step S210 is satisfied, the controller 77 reads the temperature T of the beverage container D1 or D2 detected by the temperature sensor 67 in step S220.

Next, in step S230, the controller 77 determines whether the temperature T is greater than or equal to a predetermined first threshold T1. The first threshold T1 is used to determine whether the temperature of the beverage container D1 or D2 is being kept warm, and is set to, for example, 40° C. When this determination condition is satisfied (T≥T1), the controller 77 turns on the heating retention indicator 73a in step S240. The color of emitted light is yellow, which reminds the occupant that the beverage container D1 or D2 is warm.

When the determination condition of step S230 is not satisfied (T<T1), the controller 77 determines in step S250 whether the temperature T is greater than or equal to a second threshold T2. The second threshold T2 is used to determine whether the temperature of the beverage container D1 or D2 is being kept cold, and is set to be lower than the first threshold T1 (e.g., 10° C.).

When the determination condition of step S250 is satisfied (T≥T2), the controller 77 turns on the room temperature indicator 73c in step S260. The color of emitted light is white, which reminds the occupant that the beverage container D1 or D2 is neither warm or cool. When the determination condition of step S250 is not satisfied (T<T2), the controller 77 turns on the cooling retention indicator 73b in step S270. The color of emitted light is blue, which reminds the occupant that the beverage container D1 or D2 is cool.

Subsequent to one of the above-described steps S240, S260, and S270, the controller 77 determines in step S280 that the beverage container D1 or D2 has been no longer detected. When this determination condition is not satisfied, the controller 77 returns to step S220 and repeats the processes from step S230 to S270.

When the determination condition of step S280 is satisfied, the controller 77 proceeds to step S290. In step S290, the indicator turns off the indicator 73 that has been on. After executing step S290, the controller 77 suspends the indicator control routine. When the determination condition of step S210 is not satisfied (i.e., when the beverage container D1 or D2 has not been detected by the container detection sensor 71), the controller 77 suspends the indicator control routine without executing the processes of the above-described steps S220 to step S290.

Thus, the indicator 73 emits the light of a color associated with the temperature T detected by the temperature sensor 67. The color of emitted light is set so as to remind the occupant how warm or cool the beverage container D1 or D2 is. Therefore, the temperature of the beverage container D1 or D2 is visually indicated to the occupant through the color of the emitted light. In this case, whether the beverage container D1 or D2 is being kept warm or cool is identified, and that status is displayed. Thus, the occupant readily perceives whether the beverage container D1 or D2 is warm, cold, or at a neutral temperature.

The operation of holding the beverage container D1 or D2 with the cup holder 20 will now be described.

To use the cup holder 20, as shown in FIGS. 1 and 10, the beverage container D1 or D2 is inserted into the accommodation portion 34 through the opening 27, the tubular portion 28, and the opening 37 from above the cup holder 20 and then placed on the mounting portion 52. This brings the detector 68 of the temperature sensor 67 into contact with the bottom surface of the beverage container D1 or D2. Since the detector 68 of the temperature sensor 67 is biased upward by the elastic member, the detector 68 is brought into contact with the bottom surface regardless of the type of the beverage container D1 or D2. Then, the temperature sensor 67 detects the temperature T of the beverage container D1 or D2. The beverage container D1 or D2 on the mounting portion 52 is positioned such that at least its lower part is accommodated in the accommodation portion 34.

In the cup holder 20, while the side wall 36 remains stationary, the bottom 51 moves up and down in the side wall 36. The side wall 36 includes the side heat insulator 41, which is located at least at the portion that is higher than the mounting portion 52 at its lowest point (see FIG. 10). The side heat insulator 41 includes multiple layers laminated in the thickness direction of the side wall 36. Thus, in the side wall 36, the side heat insulator 41 limits the transfer of heat in the thickness direction. As a result, temperature changes in the beverage container D1 or D2 and the beverage are limited (i.e., they are kept warm or cool) for a relatively long period.

Particularly, in the first embodiment, as shown in FIG. 3, the side heat insulator 41 has a vacuum-insulated double structure including the inner layer 42, the outer layer 43, the vacuum layer 44, and the metal foil layer 45. As a result, the vacuum layer 44 limits heat conduction and convection. Heat conduction is the transfer of heat from the higher temperature to the lower temperature through the material in contact. Convection is the process in which, due to a temperature difference, warm liquids or gases move upward and cool liquids or gases move downward, with heat being transferred along these flows. Since there are no, or very few, gas molecules in the vacuum layer 44 to transfer heat, heat is not conducted.

Heat can be transferred through radiation. This can occur even in a vacuum. However, since the metal foil layer 45 reflects heat, thermal radiation is limited. Radiation is the transfer of heat from an object to a distant location through electromagnetic waves.

As shown in FIGS. 1 and 4, when the bottom 51 moves up and down, the upper protrusion 53, the lower protrusion 56, the upper seal member 55, and the lower seal member 58 move up and down integrally with the mounting portion 52 in relation to the side wall 36. In this movement, the upper seal member 55 and the lower seal member 58 slide against the inner surface of the side wall 36.

If a beverage spills from the beverage container D1 or D2 and enters the accommodation portion 34, the beverage will flow between the bottom 51 and the side wall 36. However, the beverage is restricted from flowing downward past the upper seal member 55 by the upper seal member 55, which is in close contact with the inner surface of the side wall 36 in the thickness direction. The restricted beverage flows down into the space enclosed by the upper protrusion 53 and accumulates on the mounting portion 52. Since the upper protrusion 53 is annular and its upper end portion is located above the mounting portion 52, it is difficult for the beverage accumulated on the mounting portion 52 to flow over the upper protrusion 53.

Even if the beverage passes between the upper seal member 55 and the side wall 36 and enters the gap between the upper protrusion 53 and the side wall 36, it will be contained by the lower seal member 58, which is in close contact with the inner surface of the side wall 36. This restricts the beverage from flowing downward past the lower seal member 58.

In a state in which the bottom 51 is inserted into the side wall 36, the depth of the mounting portion 52 from the upper surface of the cup holder 20 (top plate 26) is so large that wiping off the beverage accumulated on the mounting portion 52 is difficult. In this regard, the bottom 51 can be removed from the opening 37 of the side wall 36, the tubular portion 28, and the opening 27. Moreover, when the side wall 36 is detached from the lower attachment 25, the bottom 51 can be removed from the open lower end of the side wall 36. When the bottom 51 is removed from the side wall 36, the limitation imposed by the side wall 36 is eliminated. This makes it easier to access the mounting portion 52 compared to when the bottom 51 is inserted into the side wall 36. Consequently, it becomes easier to wipe off the beverage accumulated on the mounting portion 52.

In the state in which the bottom 51 is inserted into the side wall 36, the upper seal member 55 is in tight contact with the upper protrusion 53 and the side wall 36. Further, the lower seal member 58 is in tight contact with the lower protrusion 56 and the side wall 36.

Therefore, in a state in which the bottom 51 has stopped moving up and down, the bottom 51 is held in its current vertical position, preventing any wobbling. Additionally, the removal of the bottom 51 from the side wall 36 is facilitated by elastically deforming the upper seal member 55 and the lower seal member 58.

In the same manner, the insertion of the bottom 51 into the side wall 36 is facilitated by elastically deforming the upper seal member 55 and the lower seal member 58.

### Advantages of First Embodiment

(1-1) As shown in FIGS. 1 and 2, the cup holder 20 includes the lift mechanism 65. The lift mechanism 65 is used to adjust the position of the mounting portion 52 in the vertical direction.

Thus, the lift mechanism 65 is extended and contracted to raise and lower the bottom 51, thereby changing the depth of the mounting portion 52 on which the beverage container D1 or D2 is mounted from the upper surface of the cup holder 20 (top plate 26). With this change, either the low-profile beverage container D1 (see FIG. 1) or the high-profile beverage container D2 (see FIG. 10) is stably accommodated in the accommodation portion 34 and positioned so as to be readily removed from the cup holder 20. Consequently, the cup holder 20 provides both stable retention and ease of removal of the beverage container D1 or D2.

(1-2) As shown in FIGS. 1 and 3, the side wall 36 includes the side heat insulator 41. The side heat insulator 41 includes multiple layers laminated in the thickness direction of the side wall 36 and has the layered structure, which limits the transfer of heat in the thickness direction.

Therefore, unlike the technique disclosed in Japanese Laid-Open Patent Publication No. 2003-165370, the effect of warming or cooling is maintained for a relatively long time using a simple structure without a passage that draws warm air or cool air into the accommodation portion 34.

Particularly, the side heat insulator 41 is located at least at the portion of the side wall 36 that is higher than the mounting portion 52 at its lowest point (see FIG. 10). Thus, the effect of warming or cooling is maintained regardless of the height of the mounting portion 52.

(1-3) As shown in FIGS. 1 and 10, the side wall 36 includes the bottom 51, which includes the mounting portion 52, arranged to be movable up and down from the side wall 36.

Thus, the bottom 51 is raised and lowered, thereby changing the depth of the mounting portion 52 from the upper surface of the cup holder 20 (top plate 26). As a result, the mounting portion 52 on which the beverage container D1 or D2 is mounted is raised and lowered, thereby changing the position of the beverage container D1 or D2 in the vertical direction.

(1-4) As shown in FIG. 3, the side heat insulator 41 includes the layered structure including the inner layer 42, the outer layer 43, the vacuum layer 44, and the metal foil layer 45.

This allows the vacuum layer 44 to limit heat conduction and convection. Further, the metal foil layer 45 reflects heat, thereby limiting the radiation of heat. This limits the transfer of heat in the thickness direction of the side wall 36, thereby keeping the beverage container D1 or D2 warm or cool.

(1-5) As shown in FIG. 4, the bottom 51 includes the upper protrusion 53 and the upper seal member 55.

This allows the upper seal member 55 to seal between the bottom 51 and the side wall 36. If a beverage spills from the beverage container D1 or D2 to flow between the bottom 51 and the side wall 36, the upper seal member 55 restricts the flow of the beverage downward past the upper seal member 55. The restricted beverage flows down into the space enclosed by the upper protrusion 53 and accumulates on the mounting portion 52. Further, the beverage accumulated on the mounting portion 52 is restricted from flowing over the upper protrusion 53.

(1-6) As shown in FIG. 4, the bottom 51 includes the lower protrusion 56 and the lower seal member 58.

This allows the lower seal member 58 to further increase the sealing performance between the bottom 51 and the side wall 36. Even if a beverage passes between the upper seal member 55 and the side wall 36 and enters the gap between the upper protrusion 53 and the side wall 36, the beverage will be contained by the lower seal member 58. Consequently, the beverage is restricted from flowing downward past the lower seal member 58.

Further, the lower protrusion 56 stabilizes the orientation of the bottom 51 in the side wall 36. This is because the bottom 51 becomes longer downward by an amount corresponding to the lower protrusion 56.

(1-7) As shown in FIG. 1, the side wall 36 has the shape of a tube extending in the vertical direction, with its upper and lower end portions open. The bottom 51 is inserted into the side wall 36 in a removable manner.

Accordingly, in a case in which a beverage accumulates on the mounting portion 52, the beverage on the mounting portion 52 is wiped off more easily by removing the bottom 51 from the side wall 36 compared to when the bottom 51 is inserted into the side wall 36. Thus, the performance of regular cleaning allows the mounting portion 52 to be kept clean over a longer period of time.

(1-8) Referring to FIG. 4, both the upper seal member 55 and the lower seal member 58 are formed from an elastic material.

Therefore, in a state in which the bottom 51 has stopped moving up and down, the bottom 51 is held in its current vertical position, preventing any wobbling. Additionally, the removal of the bottom 51 from the side wall 36 is facilitated by elastically deforming the upper seal member 55 and the lower seal member 58. In the same manner, the insertion of the bottom 51 into the side wall 36 is facilitated by elastically deforming the upper seal member 55 and the lower seal member 58.

(1-9) In the cup holder 20, as shown in FIGS. 1 and 2, the bottom 51, which moves up and down, is located within the side wall 36.

Therefore, the bottom 51 is almost invisible from the outside of the cup holder 20. As a result, the aesthetic appeal of the bottom 51 is not reduced or less likely to be reduced. Thus, the cup holder 20 of the first embodiment maintains a consistent aesthetic appeal regardless of the vertical position of the bottom 51, thereby enhancing the aesthetic appeal.

(1-10) As shown in FIGS. 6 and 7, the controller 77 controls the rotation of the actuator 61 to extend and contract the lift mechanism 65, thereby raising and lowering the bottom 51 as follows.

After the container detection sensor 71 detects the beverage container D1 or D2 placed on the mounting portion 52, the controller 77 lowers the bottom 51 (steps S110 and S120).

When the container detection sensor 71 no longer detects the beverage container D1 or D2 as a result of the descent, the controller 77 stops lowering the bottom 51 (steps S130 and S140).

Subsequently, the controller 77 raises the bottom 51 (steps S150 and S160).

After raising the bottom 51 to the position that is higher than the position where descent ceases by the constant height H (H=20 mm), the controller 77 stops raising the bottom 51 (steps S160 and S170).

As a result, regardless of the height of the beverage container D1 or D2, the upper end portion is exposed to the outside from the upper surface of the cup holder 20 (top plate 26). Consequently, regardless of the height of the beverage container D1 or D2, the beverage container D1 or D2 is able to be removed from the accommodation portion 34 by only pinching and gripping the upper end portion. This provides greater convenience.

(1-11) As shown in FIGS. 6 and 8, the controller 77 reads the temperature T of the beverage containers D1 or D2 detected by the temperature sensor 67 (step S220). The controller 77 selects one of the indicators 73 that emits light of the color associated with the temperature T and then turns on that indicator 73 (steps S230 to S270). The color of light emitted from each indicator 73 is set so as to remind the occupant how warm or cool the beverage container D1 or D2 is.

Therefore, the temperature of the beverage container D1 or D2 is visually indicated to the occupant through the color of the emitted light. This allows the occupant to recognize how warm or cool the beverage container D1 or D2 is; that is, recognize whether the beverage container D1 or D2 is warm, cool, or at room temperature.

(1-12) As shown in FIG. 1, the temperature sensor 67 biases the detector 68 upward using the elastic member. The temperature sensor 67 is incorporated in the mounting portion 52.

Thus, regardless of the type of the beverage container D1 or D2 placed on the mounting portion 52, the detector 68 is allowed to come into contact with the bottom surface, thereby accurately detecting the temperature of the beverage container D1 or D2.

### Second Embodiment

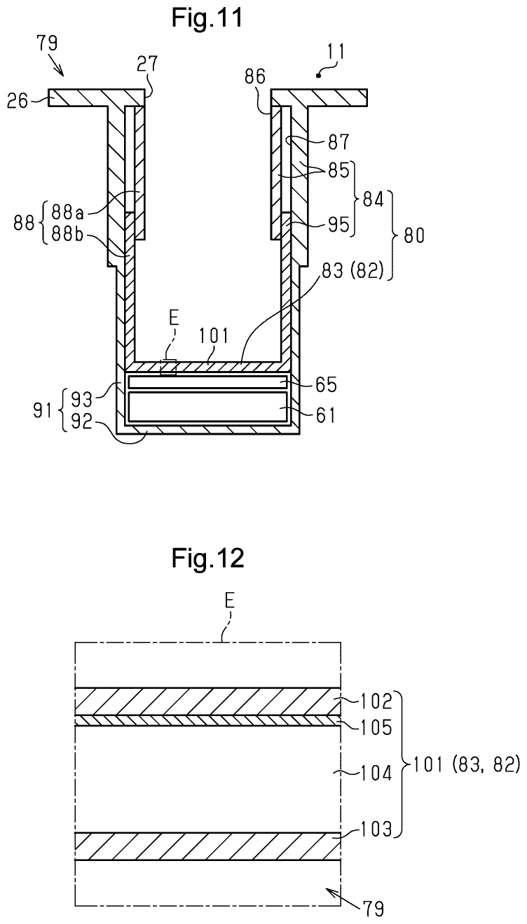

The cup holder according to a second embodiment will now be described with reference to FIGS. 11 to 13.

As shown in FIG. 11, the second embodiment of a cup holder 79 includes an accommodation portion 80. The accommodation portion 80 includes a bottom 82 with a mounting portion 83 and a side wall 84. The upper end of the accommodation portion 80 has an opening. The second embodiment is the same as the first embodiment in this respect. Further, in the same manner as the first embodiment, the position of the bottom 82 (mounting portion 83) in the vertical direction is adjustable.

However, the bottom 82 is composed solely of a flat mounting portion 83. The bottom 82, unlike the first embodiment, does not have sections corresponding to the upper protrusion 53 and the lower protrusion 56.

Additionally, the side wall 84 includes a tubular fixed side wall portion 85 that extends in the vertical direction, and a tubular movable side wall portion 95 that extends in the vertical direction. The side wall 84 surrounds a beverage container (not shown) placed on the mounting portion 83.

The upper end of the fixed side wall portion 85 has an opening 86. The opening 86 defines the opening of the accommodation portion 80. The fixed side wall portion 85 includes an annular accommodation portion 87 having an open lower end and extending in the vertical direction. The annular accommodation portion 87 is located at an intermediate part of the side wall 84 in the thickness direction. The fixed side wall portion 85 has a fixed side heat insulator portion 88a, which form part of the side heat insulator 88, located inward from the annular accommodation portion 87 in the thickness direction. The fixed side heat insulator portion 88a is arranged on the entirety of a section of the fixed side wall portion 85 in the vertical direction, the section being located inward from the annular accommodation portion 87 in the thickness direction.

An accommodation wall 91 is arranged on the lower side of the fixed side wall portion 85. The accommodation wall 91 includes a bottom wall portion 92 and a protruding wall portion 93 that extends upward from a peripheral edge of the bottom wall portion 92. The upper end portion of the protruding wall portion 93 is connected to the lower end portion of a part of the fixed side wall portion 85 located outward from the annular accommodation portion 87 in the thickness direction.

The accommodation wall 91 includes the lift mechanism 65 and the actuator 61 in the same manner as the first embodiment. The actuator 61 is fixed to the bottom wall portion 92. The lift mechanism 65 is located above the actuator 61, with its lower end connected to the actuator 61 and its upper end connected to the mounting portion 83.

The lower end portion of the movable side wall portion 95 is fixed to a peripheral edge of the mounting portion 83 and configured to move up and down in the annular accommodation portion 87 as the bottom 82 (mounting portion 83) moves up and down. The position of the bottom 82 (mounting portion 83) in the vertical direction is adjusted by raising and lowering the bottom 82 (mounting portion 83).

The movable side wall portion 95 includes a movable side heat insulator portion 88b, which forms part of the side heat insulator 88. The movable side heat insulator portion 88b is arranged on the entire movable side wall portion 95 in the vertical direction. Thus, the side heat insulator 88 is located at least at a portion of the side wall 84 that is higher than the mounting portion 83 at its lowest point.

The fixed side heat insulator portion 88a and the movable side heat insulator portion 88b have the same layered structure as that of the side heat insulator 41 in the first embodiment.

As shown in FIGS. 11 and 12, the mounting portion 83 of the second embodiment includes a bottom heat insulator 101. The bottom heat insulator 101 includes multiple layers laminated in the vertical direction, which is the thickness direction of the mounting portion 83, and has a layered structure that limits the transfer of heat in the vertical direction. The upper side in the vertical direction corresponds to the inner side in the thickness direction of the mounting portion 83. The lower side in the vertical direction corresponds to the outer side in the thickness direction of the mounting portion 83. Except the laminating direction, the layered structure of the bottom heat insulator 101 is the same as that of the side heat insulator 41. That is, the layered structure of the bottom heat insulator 101 includes an inner layer 102, an outer layer 103, a vacuum layer 104, and a metal foil layer 105. The inner layer 102 is located at the uppermost (innermost) part of the bottom 82 (mounting portion 83) in the vertical direction. The outer layer 103 is located on the lower (outer) side of the inner layer 102 at a position separated by a certain distance. The outer layer 103 is located at the lowermost (outermost) part of the bottom 82 (mounting portion 83) in the vertical direction. The vacuum layer 104 is formed between the inner layer 102 and the outer layer 103. The metal foil layer 105 is located between the inner layer 102 and the outer layer 103. In the second embodiment, the metal foil layer 105 is laminated on the lower (outer) surface of the inner layer 102. The peripheral edge of the bottom heat insulator 101 may be connected to the lower end portion of the movable side heat insulator portion 88b, or may be spaced apart from the lower end portion. The term “connected” refers to a state in which the inner layer 102 is connected to the inner layer 42, the outer layer 103 is connected to the outer layer 43, and the vacuum layer 104 is connected to the vacuum layer 44. The metal foil layer 105 may be connected to the metal foil layer 45, or may be spaced apart from the metal foil layer 45.

Other than the above-described differences, the second embodiment is the same as the first embodiment. The components that are the same as those of the first embodiment include the temperature sensor 67, the container detection sensor 71, the indicator 73, and the controller 77, all of which are not illustrated in the drawings. The controller 77 executes the same processes as the first embodiment. Specifically, the controller 77 executes the processes of the lift control routine and the processes of the indicator control routine. In the second embodiment, same reference numerals are given to those components that are the same as the corresponding components of the first embodiment. Such components will not be described in detail.

### Operation of the Second Embodiment

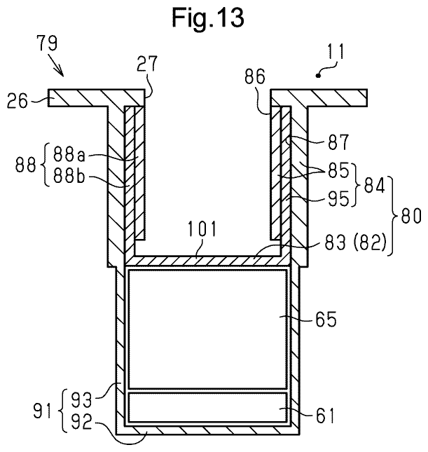

The above-described second embodiment produces the same operation as the first embodiment. Further, in the second embodiment, as shown in FIGS. 11 and 13, the fixed side wall portion 85 remains stationary, while the movable side wall portion 95 moves up and down in the annular accommodation portion 87 as the bottom 82 (mounting portion 83) moves up and down. The depth of the mounting portion 83 from the upper surface of the cup holder 79 (top plate 26) is adjusted by the vertical movement of the bottom 82 (mounting portion 83). As the mounting portion 83 on which a beverage container is placed moves up and down, the position of the beverage container in the vertical position changes.

The fixed side heat insulator portion 88a is arranged at the above-described portion of the fixed side wall portion 85, and the movable side heat insulator portion 88b is arranged at the movable side wall portion 95. Thus, the side wall 84 includes the side heat insulator 88 located at least at the portion that is higher than the mounting portion 83 at its lowest point. The fixed side heat insulator portion 88a and the movable side heat insulator portion 88b limit the transfer of heat in the thickness directions of the fixed side wall portion 85 and the movable side wall portion 95.

Further, as shown FIG. 11, when the bottom 82 (mounting portion 83) and the movable side wall portion 95 are lowered, the air within the annular accommodation portion 87 exerts a heat insulating effect.

Furthermore, as shown in FIG. 12, the bottom heat insulator 101, which includes multiple layers laminated in the vertical direction (the thickness direction of the mounting portion 83), limits the transfer of heat in the vertical direction.

### Advantage of Second Embodiment

The second embodiment thus achieves the same advantages as the advantages (1-1) to (1-4) and (1-9) to (1-12) of the first embodiment. In addition to the ones listed above, the second embodiment achieves the following advantages.

(2-1) As shown in FIGS. 11 and 13, the side wall 84 includes the tubular fixed side wall portion 85, which extends in the vertical direction and has the opening 86 at its upper end, and the tubular movable side wall portion 95, which extends in the vertical direction and has the open upper end. The fixed side wall portion 85 includes the annular accommodation portion 87, which has the open lower end and extends in the vertical direction. The annular accommodation portion 87 is located at the intermediate part of the side wall 84 in the thickness direction.

The fixed side wall portion 85 includes the fixed side heat insulator portion 88a, which is located inward from the annular accommodation portion 87. The movable side wall portion 95 includes the movable side heat insulator portion 88b. The movable side wall portion 95 is fixed to the peripheral edge of the bottom 82, and moves up and down in the annular accommodation portion 87 as the bottom 82 (mounting portion 83) moves up and down. The fixed side heat insulator portion 88a is arranged on the entirety of the section of the fixed side wall portion 85 in the vertical direction, the section being located inward from the annular accommodation portion 87 in the thickness direction of the side wall 84. The movable side heat insulator portion 88b is arranged at least at the portion of the movable side wall portion 95 that is higher than the mounting portion 83.

Therefore, the fixed side heat insulator portion 88a and the movable side heat insulator portion 88b limit the transfer of heat in the thickness direction of the side wall 84. This allows a beverage container and a beverage to be kept warm or cool for a relatively long period.

Further, when the bottom 82 (mounting portion 83) and the movable side wall portion 95 are lowered, the air within the annular accommodation portion 87 exerts a heat insulating effect. This allows the fixed side wall portion 85 to produce a greater heat insulating effect.

(2-2) As shown in FIGS. 11 and 12, the bottom 82 (mounting portion 83) includes the bottom heat insulator 101. The bottom heat insulator 101 includes multiple layers (the inner layer 102, the outer layer 103, the vacuum layer 104, and the metal foil layer 105) laminated in the vertical direction (the thickness direction of the mounting portion 83). Further, the bottom 82 has the layered structure, which limits the transfer of heat in the vertical direction.

Thus, this configuration achieves the same advantage as the described advantage (1-4). That is, the vacuum layer 104 limits heat conduction and convection. Further, the metal foil layer 105 reflects heat, thereby limiting the radiation of heat. This limits the transfer of heat in the vertical direction (the thickness direction of the mounting portion 83) at the bottom 82 (mounting portion 83). Consequently, the effect of keeping the container warm or cool is higher compared to a configuration in which the bottom 82 (mounting portion 83) does not include the bottom heat insulator 101.

### Third Embodiment

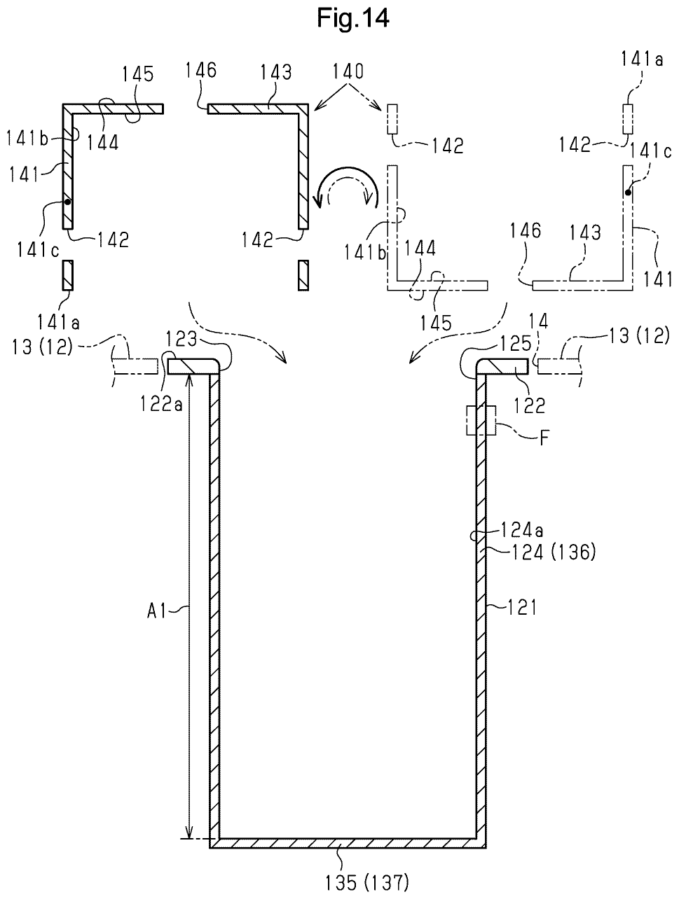

The cup holder according to a third embodiment will now be described with reference to FIGS. 14 to 17.

As shown in FIGS. 14 to 16, the cup holder 120 of the third embodiment includes a spacer 140 with a mounting portion 143 to adjust the position of the mounting portion 143 in the vertical direction. The mounting portion 143 forms part of an accommodation portion 121. The components of the cup holder 120 will now be described.

### Accommodation Portion 121

As shown in FIG. 14, the accommodation portion 121 of the third embodiment includes a top plate 122, a side wall 124, and a bottom 135.

The top plate 122 is annular, and is located in the opening 14 of the upper wall 13 in the interior component 12. The top plate 122 has an upper surface 122a, which defines the upper surface of the cup holder 120. The top plate 122 includes a circular opening 123. The inner diameter of the opening 123 is sized such that the beverage container D1 or D2 can be inserted through the opening 123 in the vertical direction.

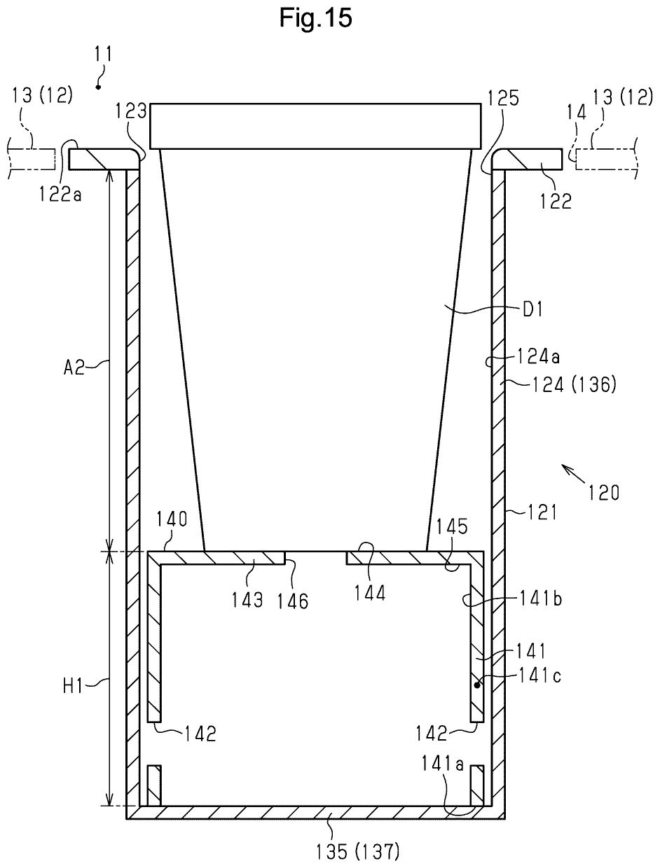

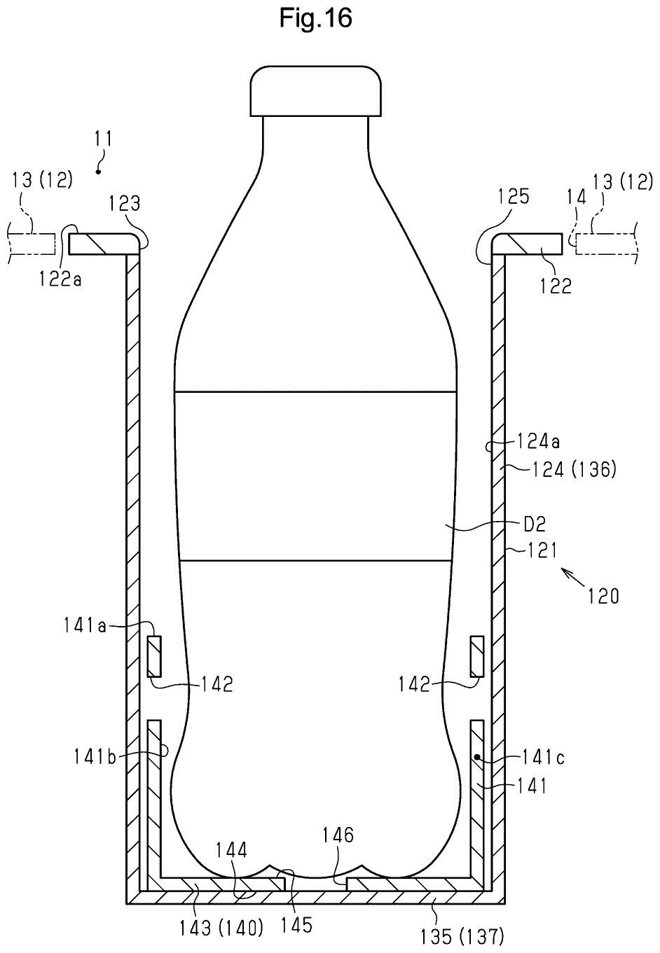

The side wall 124 has the shape of a cylinder that extends in the vertical direction. The side wall 124 is located below a peripheral edge of the opening 123 in the top plate 122. The side wall 124 has an opening 125 at its an upper end. The upper end portion of the side wall 124 is fixed to the peripheral edge of the opening 123 of the top plate 122. The inner diameter of the side wall 124 remains the same at any position of the side wall 124 in the vertical direction, and is set to be the same as or almost the same as the inner diameter of the opening 123. The side wall 124 surrounds the beverage container D1 or D2 that is placed on the mounting portion 143 of the spacer 140 (see FIGS. 15 and 16).

The bottom 135 is circular. The bottom 135 has a peripheral edge coupled to the lower end portion of the side wall 124. The coupling may be performed by forming the bottom 135 integrally with the side wall 124. Alternatively, the coupling may be performed by fixing a bottom 135 that is separate from the side wall 124 to the lower end portion of the side wall 124.

In the accommodation portion 121, the space surrounded by the top plate 122, the side wall 124, and the bottom 135 accommodates at least the lower part of each of the beverage containers D1 and D2.

As shown in FIGS. 14 and 16, a depth A1 from the upper end surface of the side wall 124 (the lower surface of the top plate 122) to the lower end surface of the side wall 124 (the upper surface of the bottom 135) is set to approximately 200 mm, for example. The depth A1 allows the upper end portion of the beverage container D2 to be exposed upward from the upper surface of the cup holder 120 when a 600-milliliter plastic bottle, as the beverage container D2, is accommodated in the accommodation portion 121 (i.e., when the bottle is placed on the bottom 135).

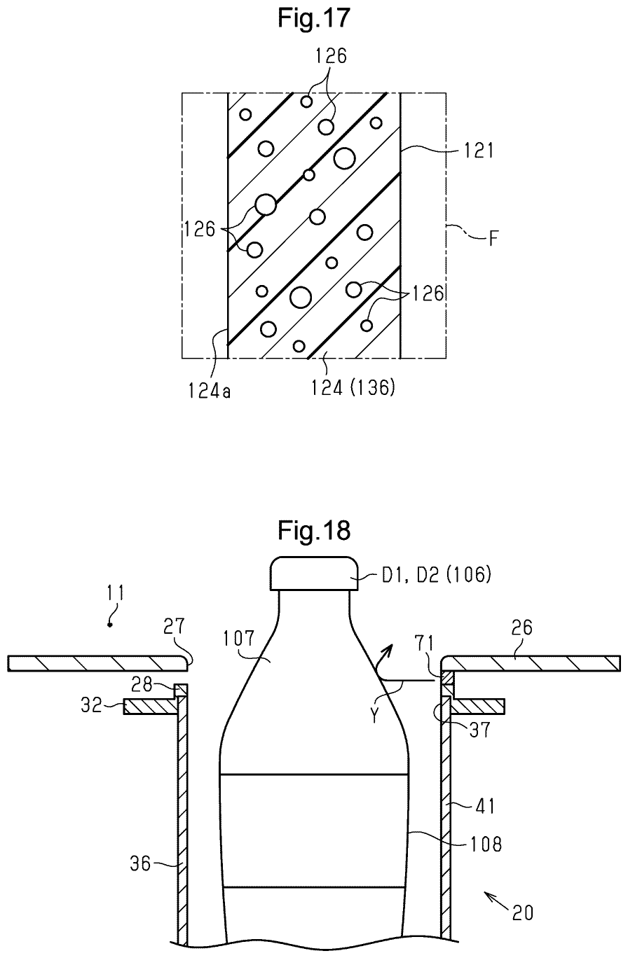

As shown in FIG. 17, the side wall 124 includes a side heat insulator 136 that limits the transfer of heat in the thickness direction of the side wall 124. The position of the side heat insulator 136 in the vertical direction of the side wall 124 will be described later. The side heat insulator 136 is formed from a foamed resin material. In the third embodiment, the side heat insulator 136 is formed using a rigid foamed urethane as a foamed resin material. The side heat insulator 136, which is formed using a foamed resin material, contains bubbles 126.

### Spacer 140

As shown in FIG. 14, the spacer 140 is used to adjust the position of the beverage container D1 or D2 accommodated in the accommodation portion 121 in the vertical direction (hereinafter referred to as the vertical position). The spacer 140 is arranged in the side wall 124 in a removable manner. The spacer 140 includes a cylindrical leg 141 that extends in the vertical direction, and a mounting portion 143 arranged at a portion shifted from a middle part 141c of the leg 141 toward one end of the spacer 140 in the vertical direction. The outer diameter of the leg 141 is set to be slightly smaller than the inner diameter of the side wall 124.

Further, the mounting portion 143 of the third embodiment is circular, and is coupled to the one end of the leg 141 in the vertical direction. The coupling may be performed by forming the mounting portion 143 integrally with the leg 141. Alternatively, the coupling may be performed by fixing a mounting portion 143 that is separate from the leg 141 to the one end of the leg 141. The outer diameter of the mounting portion 143 is set to be the same as or almost the same as the outer diameter of the leg 141.

When the outer diameters of the leg 141 and the mounting portion 143 are set to satisfy the above-described conditions, the spacer 140 is movable in the side wall 124 in the vertical direction along an inner wall surface 124a of the side wall 124. The spacer 140 arranged in the side wall 124 can be removed from the side wall 124 through the openings 125 and 123 by being moved upward. The spacer 140 arranged outside of the side wall 124 can be inserted into the side wall 124 through the openings 123 and 125 and moved downward along the inner wall surface 124a.

The orientation in which the spacer 140 is arranged in the side wall 124 includes a first orientation and a second orientation. In the first orientation, as shown by the solid line in FIG. 14, the mounting portion 143 is located at the upper end portion of the leg 141, which is located above the middle part 141c of the leg 141. In the second orientation, as shown by the broken line in FIG. 14, the mounting portion 143 is located at the lower end portion of the leg 141, which is located below the middle part 141c of the leg 141.

The positional adjustment of the mounting portion 143 in the vertical direction is performed by switching the orientation of the spacer 140.

The mounting portion 143 includes a first mounting surface 144 and a second mounting surface 145. The first mounting surface 144 is one surface of the mounting portion 143 in the vertical direction, and the second mounting surface 145 is the other surface. As shown in FIG. 15, the first mounting surface 144 is a surface on which the low-profile beverage container D1 is placed when the spacer 140 is oriented in the first orientation. As shown in FIG. 16, the second mounting surface 145 is a surface on which the high-profile beverage container D2 is placed when the spacer 140 is oriented in the second orientation.

As shown in FIG. 14, the mounting portion 143 includes a first finger hook 146 that has a hole extending through the mounting portion 143 in the vertical direction. Additionally, the leg 141 includes a second finger hook 142 that has a hole extending through the leg 141 in the thickness direction of the side wall 124 (the lateral direction in FIG. 14). There may be one first finger hook 146 and one second finger hook 142. Alternatively, there may be multiple first finger hooks 146 and multiple second finger hooks 142.

As shown in FIG. 15, the height H1 of the spacer 140 in the first orientation (i.e., the dimension from the first mounting surface 144 of the mounting portion 143 to an end surface 141a of the leg 141 on the side farther from the mounting portion 143 in the vertical direction) is set to approximately 80 mm. This value allows the upper end portion of the low-profile beverage container D1 to be exposed upward from the upper surface of the cup holder 120 when the beverage container D1 is placed on the spacer 140 arranged in the first orientation within the side wall 124. When the spacer 140 is arranged in the first orientation within the side wall 124, the depth A2 from the upper end surface of the side wall 124 (the lower surface of the top plate 122) to the first mounting surface 144 is approximately 120 mm. The value of 120 mm is obtained by subtracting the height H1 of the spacer 140, which is 80 mm, from the depth A1 of the side wall 124, which is 200 mm.

The side heat insulator 136 is arranged at least at a portion of the side wall 124 that is higher than the mounting portion 143 at its lowest point. As shown in FIG. 16, the mounting portion 143 is located at its lowest point when the spacer 140 is oriented in the second orientation (i.e., when the mounting portion 143 is placed on the bottom 135). Therefore, substantially the entire side wall 124, except its lower end portion, is formed by at least the side heat insulator 136.

In the third embodiment, unlike the first and second embodiments, neither the actuator 61 nor the lift mechanism 65 is used.

### Operation of the Third Embodiment

First, the operation of holding the low-profile beverage container D1 with the cup holder 120 will be described.

In this case, as shown in FIG. 15, the spacer 140 is arranged in the first orientation within the side wall 124. The mounting portion 143 is located at the upper end portion of the leg 141, and the first mounting surface 144 is defined by the upper surface of the mounting portion 143. The depth of the mounting portion 143 from the upper surface of the cup holder 120 is smaller as compared to when the spacer 140 is arranged within the side wall 124 in the second orientation. The first mounting surface 144 is located at a point above the upper surface of the bottom 135 by the height H1 (80 mm) and below the upper end surface of the side wall 124 (the lower surface of the top plate 122) by the depth A2 (120 mm).

The beverage container D1 is inserted into the accommodation portion 121 through the openings 123 and 125 from above the cup holder 120 and placed on the first mounting surface 144. The upper end portion of the beverage container D1 is located proximate to the openings 123 and 125 and exposed upward from the upper surface of the cup holder 120. This allows a user of the cup holder 120 to readily remove the beverage container D1 from the accommodation portion 121 by pinching the exposed part of the top plate 122 of the beverage container D1 with the fingers and lifting the exposed part.

Further, the majority of the beverage container D1 excluding its upper end portion is accommodated in the space of the accommodation portion 121 above the first mounting surface 144 (i.e., the space between the mounting portion 143 and the opening 123). Thus, the beverage container D1 is stably accommodated in the accommodation portion 121.

Next, the operation of holding the high-profile beverage container D2 with the cup holder 120 will be described.

In this case, as shown in FIG. 16, the spacer 140 is arranged in the second orientation within the side wall 124. The mounting portion 143 at the lower end portion of the leg 141 is superimposed on the bottom 135. The first mounting surface 144 of the mounting portion 143 is in contact with the upper surface of the bottom 135. The second mounting surface 145, which is defined by the upper surface of the mounting portion 143, is located at a position higher than the upper surface of the bottom 135 by the thickness of the mounting portion 143. The depth of the mounting portion 143 from the upper surface of the cup holder 120 is greater as compared to when the spacer 140 is arranged in the first orientation within the side wall 124.

The beverage container D2 is inserted into the accommodation portion 121 through the openings 123 and 125 from above the cup holder 120 and placed on the second mounting surface 145. The upper end portion of the beverage container D2 is located proximate to the openings 123 and 125 and exposed upward from the upper surface of the cup holder 120. This allows the user of the cup holder 120 to readily remove the beverage container D2 from the accommodation portion 121 by pinching the exposed part of the top plate 122 of the beverage container D2 with the fingers and lifting the exposed part.

Further, the majority of the beverage container D2 excluding its upper end portion is accommodated in the space of the accommodation portion 121 above the second mounting surface 145 (i.e., the space between the mounting portion 143 and the opening 123). Thus, the beverage container D2 is stably accommodated in the accommodation portion 121.

Next, the operation of switching the spacer 140 from the first orientation to the second orientation and the operation of switching from the second orientation to the first orientation will be described.

In this case, the spacer 140 with no beverage container D1 or D2 placed is moved upward in the side wall 124.

As shown in FIG. 15, if the first mounting surface 144 of the spacer 140 arranged in the first orientation within the side wall 124 is smooth and thus the mounting portion 143 does not have a portion to hook a finger, it would be difficult for the user of the cup holder 120 to remove the spacer 140 from the side wall 124 by moving the spacer 140 upward.

In the third embodiment, the user inserts the finger into the first finger hook 146 of the mounting portion 143. This causes the finger to be locked on the first finger hook 146. Thus, when the user raises the finger locked on the first finger hook 146, the spacer 140 moves upward along the inner wall surface 124a of the side wall 124 together with the finger. This movement allows the spacer 140 to be removed from the side wall 124.

As shown in FIG. 16, if the leg 141 of the spacer 140 arranged in the second orientation within the side wall 124 is smooth and thus the inner side surface 141b of the leg 141 does not have a portion to hook a finger, it would be difficult for the user of the cup holder 120 to remove the spacer 140 from the side wall 124 by moving the spacer 140 upward.

In the third embodiment, the user inserts the finger into the second finger hook 142 of the leg 141. This causes the finger to be locked on the second finger hook 142. Thus, when the user raises the finger locked on the second finger hook 142, the spacer 140 moves upward along the inner wall surface 124a of the side wall 124 together with the finger. This movement allows the spacer 140 to be removed from the side wall 124.

When the spacer 140 is removed from the side wall 124 through the openings 125 and 123, the spacer 140 is turned upside down such that its positional relationship is reversed at the outside of the side wall 124 as shown by the arrow in FIG. 14. The reversed spacer 140 is inserted into the side wall 124 through the openings 123 and 125. The spacer 140 is moved downward along the inner wall surface 124a of the side wall 124.

To hold the high-profile beverage container D2 with the cup holder 120, the spacer 140 may be removed from the side wall 124. Then, the beverage container D2 may be inserted into the accommodation portion 121 and placed on the bottom 135.

Next, the operation of keeping the beverage container D1 or D2 warm or cool will be described.

The side wall 124 of the accommodation portion 121 includes the side heat insulator 136, which is formed from a rigid foamed urethane as a foamed resin material. As shown in FIG. 17, the bubbles 126 contained in the side heat insulator 136 exert a heat insulating effect, thereby limiting heat conduction. Thus, in the side heat insulator 136, the bubbles 126 limit the transfer of heat in the thickness direction of the side wall 124. As a result, temperature changes in the beverage container D1 or D2 and the beverage are limited for a relatively long period.

### Advantages of Third Embodiment

(3-1) As shown in FIGS. 14 and 15, the cup holder 120 includes the side wall 124 and the spacer 140, which is arranged in the side wall 124 in a removable manner. The spacer 140 includes the leg 141, which extends in the vertical direction, and the mounting portion 143, which is arranged at a position shifted from the middle part 141c toward one end of the leg 141 in the vertical direction. The orientations of the spacer 140 arranged in the side wall 124 include the first orientation (see FIG. 15), in which the mounting portion 143 is located above the middle part 141c of the leg 141, and the second orientation (see FIG. 16), in which the mounting portion 143 is located below the middle part 141c of the leg 141. The mounting portion 143 includes the first mounting surface 144, on which the low-profile beverage container D1 is mounted when the spacer 140 is arranged in the first orientation, and the second mounting surface 145, on which the high-profile beverage container D2 is mounted when the spacer 140 is arranged in the second orientation.

This configuration allows the position of the mounting portion 143 in the vertical direction to be adjusted by switching the orientation of the spacer 140 between the first orientation, which is shown by the solid line in FIG. 14, and the second orientation, which is shown by the broken line in FIG. 14. Also, this configuration allows for a change in the depth of the mounting portion 143 on which the beverage container D1 or D2 is mounted from the upper surface of the cup holder 120. As shown in FIG. 15, when the spacer 140 is arranged in the first orientation, the upper end portion of the low-profile beverage container D1 is exposed upward from the upper surface of the cup holder 120 and the portion located below the upper end portion of the beverage container D1 is accommodated in the accommodation portion 121. As shown in FIG. 16, when the spacer 140 is arranged in the second orientation, the upper end portion of the high-profile beverage container D2 is exposed upward from the upper surface of the cup holder 120 and the portion located below the upper end portion of the beverage container D2 is accommodated in the accommodation portion 121.

Consequently, either the high-profile beverage container D2 or the low-profile beverage container D1 is stably accommodated in the accommodation portion 121 and held in the vertical position that facilitates the removal from the cup holder 120.

Hence, the beverage containers D1 and D2, each having a different height, are held with a simple configuration in which the spacer 140, whose orientation is switchable between the first orientation and the second orientation, is arranged in the side wall 124 in a removable manner.

9 (3-2) In relation to advantage (3-1), the mounting portion 143 of the third embodiment is arranged at one end of the leg 141 in the vertical direction.

Accordingly, the difference between the vertical position of the mounting portion 143 with the spacer 140 in the first orientation, which is shown in FIG. 15, and the vertical position of the mounting portion 143 with the spacer 140 in the second orientation, which is shown in FIG. 16, is the maximum possible value. In other words, when the spacer 140 is arranged in the first orientation, the mounting portion 143 is located at the highest possible point. When the spacer 140 is arranged in the second orientation, the mounting portion 143 is located at the lowest possible point. Thus, the above-described spacer 140, in which the mounting portion 143 is arranged at the one end of the leg 141 in the vertical direction, is effective for holding the beverage containers D1 and D2, each having a different height.

(3-3) As shown in FIG. 14, the mounting portion 143 includes the first finger hook 146, which has the hole extending through the mounting portion 143 in the vertical direction.

Accordingly, when the spacer 140 is arranged in the first orientation within the side wall 124 and the beverage container D1 is not placed, the user of the cup holder 120 removes the spacer 140 from the side wall 124 by inserting the finger into the first finger hook 146 and lifting the first finger hook 146.

(3-4) As shown in FIG. 14, the leg 141 includes the second finger hook 142, which has the hole extending through the leg 141 in the thickness direction of the side wall 124.

Accordingly, when the spacer 140 is arranged in the second orientation within the side wall 124 and the beverage container D2 is not placed, the user of the cup holder 120 removes the spacer 140 from the side wall 124 by inserting the finger into the second finger hook 142 and lifting the first finger hook 146.

(3-5) As shown in FIG. 17, the side wall 124 includes the side heat insulator 136. The side heat insulator 136 is formed from a rigid foamed urethane, which is foamed resin material.

Accordingly, the transfer of heat from the side heat insulator 136 in the thickness direction of the side wall 124 is limited by the bubbles 126. As a result, the temperature changes in the beverage container D1 or D2 and the beverage are limited (i.e., the beverage container D1 or D2 is kept warm or cool) for a relatively long period.

Thus, unlike the technique disclosed in Japanese Laid-Open Patent Publication No. 2003-165370, the effect of warming or cooling is maintained for a relatively long time using a simple structure without a passage that draws warm air or cool air into the accommodation portion 121.

In particular, the side heat insulator 136 is provided on substantially the entire side wall 124 except the lower end portion. Consequently, the effect of keeping the container warm or cool is achieved regardless of the height of the mounting portion 143.

(3-6) In the cup holder 120, as shown in FIGS. 15 and 16, the spacer 140 is located in the lower part of the side wall 124.

Therefore, the spacer 140 is almost invisible from the outside of the cup holder 120. As a result, the aesthetic appeal of the spacer 140 is not lowered or is less likely to be lowered. Thus, the cup holder 120 of the third embodiment maintains a consistent aesthetic appeal regardless of the orientation of the spacer 140. This enhances the appearance.

### Modifications

The above-described embodiments may be modified as follows. The above-described embodiments and the following modifications can be combined as long as the combined modifications remain technically consistent with each other.

### Modifications of Accommodation Portions 34 and 80

The metal foil layer 45 in the side heat insulator 41 shown in FIG. 3 may be laminated on the inner surface of the outer layer 43 in the thickness direction of the side wall 36 (the surface on the left side in FIG. 3), instead of or in addition to being laminated on the outer surface of the inner layer 42 in the thickness direction (the surface on the right side in FIG. 3).

Similarly, the metal foil layer 105 of the bottom heat insulator 101 shown in FIG. 12 may be laminated on the upper surface of the outer layer 103 (i.e., the inner surface of the mounting portion 83 in the thickness direction), instead of or in addition to being laminated on the lower surface (outer surface) of the inner layer 102.

In the first embodiment (FIG. 3), instead of the metal foil layer 45, a plating layer formed from silver or the like may be formed on at least one of the outer surface of the inner layer 42 and the inner surface of the outer layer 43 in the thickness direction of the side wall 36.

In the second embodiment (FIG. 12), instead of the metal foil layer 105, a plating layer formed from silver or the like may be formed on at least one of the lower surface of the inner layer 102 and the upper surface of the outer layer 103. The lower surface of the inner layer 102 is the outer surface of the inner layer 102 in the thickness direction of the mounting portion 83. The upper surface of the outer layer 103 is the inner surface of the outer layer 103 in the thickness direction of the mounting portion 83.

In the same manner as the above, heat attempting to radiate outside the layered structure is reflected by the plating layer toward the inner side of the layered structure in the thickness direction of the side wall 36 or the thickness direction of the mounting portion 83 (vertical direction) so that the heat is trapped inside. As a result, a heat insulating effect is gained.

In the first embodiment, the lower seal member 58 may be omitted. In this case, the lower protrusion 56 of the bottom 51 may either be provided or omitted. If the lower protrusion 56 remains, the position of the bottom 51 in the side wall 36 is stabilized.

In the first embodiment, the side wall 36 does not have to be cylindrical and may be polygonal. Likewise, in the second embodiment, the fixed side wall portion 85 and the movable side wall portion 95 do not have to be cylindrical and may be polygonal.

The mounting portion 52 of the first embodiment may include a bottom heat insulator that has the same configuration as the bottom heat insulator 101 of the mounting portion 83 in the second embodiment.

In the same manner as the mounting portion 52 of the first embodiment, the mounting portion 83 of the second embodiment without the bottom heat insulator 101 may be employed.

In the second embodiment, the mounting portion 83 (bottom 82) may be fixed to the movable side wall portion 95 at a position higher than the lower end portion of the movable side wall portion 95. In this case, the movable side wall portion 95 includes a section that is located below the mounting portion 83 (bottom 82). It is desirable that the section of the movable side wall portion 95 located below the mounting portion 83 (bottom 82) be formed by the movable side heat insulator portion 88b. However, this configuration does not have to be employed.

Instead of or in addition to the part of the side wall 84 located inward from the annular accommodation portion 87 in the thickness direction, the fixed side wall portion 85 of the second embodiment may include the fixed side heat insulator portion 88a at the outer part.

In the cup holder 20 of the first embodiment, the upper and lower ends of the side wall 36 are open. When a warm beverage container D1 or D2 is accommodated in the accommodation portion 34, the transfer of heat is limited by the side heat insulator 41. However, the temperature of the beverage container D1 or D2 gradually decreases as time passes. When the occupant touches the cooled beverage container D1 or D2 with their lips to drink, the occupant feels a lukewarm sensation through their skin. As a result, the occupant may feel that the beverage in the beverage container D1 or D2 is lukewarm before drinking it. FIG. 20 illustrates a beverage can as the beverage container D1 or D2.

To solve the above-described problem, as shown in FIG. 20, a heater 115 may be arranged at a position of the side wall 36 that does not hinder vertical movement of the bottom 51 or activation of the lift mechanism 65. The heater 115 reheats the beverage container D1 or D2. The heater 115 may be arranged at, for example, a position of the side wall 36 adjacent to the lower side of the mounting portion 52 that is located at its lower point. Examples of the heater 115 include a film heater and a PTC heater. The film heater heats the film through the passage of current in wires embedded in the film, generating heat through electrical resistance. The PTC heater is a type of heater that has PTC characteristics, where the electrical resistance value changes with an increase in temperature, following a positive coefficient.

When the temperature of the beverage container D1 or D2 detected by the temperature sensor 67 is lower than a predetermined threshold, the temperature of the beverage container D1 or D2 is raised by energizing the heater 115, which is used for reheating. Considering the heat resistance temperature of commercially available plastic bottles and the temperature at which coffee, a typical beverage, is considered enjoyable, the threshold is preferably set to a value in the range of 45° C. to 50° C.

This modification allows the beverage container D1 or D2, such as a beverage can, to be heated before drinking the beverage. By making the occupant feel the warmth through their skin when touching the beverage container D1 or D2, the beverage inside the beverage container D1 or D2 is perceived as warm.

Further, this modification allows the beverage in the beverage container D1 or D2 to be heated.

Furthermore, the side wall 36 is heated to enhance the effect of keeping the container warm.

### Modifications of Lift Mechanism 65

In the first and second embodiments, as long as the lift mechanism is activated by an actuator to raise and lower the bottoms 51 and 82, the above-described pantograph-type link mechanism does not have to be employed.

For example, the lift mechanism may include a pinion gear that rotates as the rotary shaft of the actuator rotates, and a rack gear that extends in the vertical direction and is coupled to the bottom 51 or 82. The rack gear is meshed with the pinion gear. In this case, the pinion gear rotates integrally with the rotary shaft of the actuator, and the rack gear meshed with the pinion gear moves vertically. As a result, the bottom 51 or 82 moves up and down.

In contrast, the pinion gear may be attached to the bottom 51 or 82 and the rack gear extending in the vertical direction is attached to the side wall 36 or the like. Further, the rack gear may be meshed with the pinion gear. In this modification, as the actuator rotates the pinion gear, the position of the pinion gear meshed with the rack gear changes in the vertical direction. As a result, the bottom 51 or 82 moves up and down.

The lift mechanism of the first embodiment may have the following configuration. Two cylindrical members, each having a different diameter, are arranged in a cylindrical side wall 36 and between the outer circumferential surface of the mounting portion 52 and the inner surface of the side wall 36. Their central axes coincide with each other. To distinguish the two cylindrical members from each other, the one with a smaller diameter is referred to as the internal cylindrical member and the one with a larger diameter is referred to as the external cylindrical member. The internal cylindrical member is non-rotatable, while the external cylindrical member is rotatable.

The two portions of the internal cylindrical member that are located on the opposite sides of the central axis respectively have vertical slits extending in the vertical direction. The inner surface of the external cylindrical member has a helical groove that helically extends around the central axis. Pins are respectively provided at two portions of the outer circumferential surface of a circular mounting portion 52 on the opposite sides of the central axis. The pins protrude outward in the radial direction. Each pin is engaged with the intersection between each vertical slit and the helical groove.

In this configuration, as the external cylindrical member rotates, the intersection between the vertical slit and the helical groove moves in the vertical direction. This movement is transmitted to the mounting portion 52 through the two pins, causing the mounting portion 52 to move up and down.

The external cylindrical member may be rotated, for example, as follows. A ring gear is rotationally provided integrally with the outer circumference of the external cylindrical member. A gear that rotates integrally with the rotary shaft of the actuator is engaged with the ring gear. In this case, as the rotary shaft of the actuator rotates, that rotation is transmitted to the external cylindrical member through the gear and the ring gear. Consequently, the external cylindrical member rotates around the central axis.

The lift mechanism 65 may be operated manually instead of using the actuator 61.

### Modifications of Temperature Sensor 67 and Container Detection Sensor 71

The temperature sensor 67 may detect the temperature T without coming into contact with the beverage container D1 or D2.

In the first embodiment, the container detection sensor 71 is a reflective IR sensor. In this modification, as shown in FIG. 18, if the beverage container D1 or D2 placed on the mounting portion 52 includes a portion that is significantly inclined relative to a vertical line. Such a beverage container D1 or D2 is, for example, a plastic bottle 106. The portion of the plastic bottle 106 that is significantly inclined relative to the vertical line is, for example, a neck 107.

The plastic bottle 106 placed on the mounting portion 52 includes a body 108. When the body 108 is located at the same height as or at almost the same height as the container detection sensor 71, the light-emitting element emits light and the light-receiving element receives the infrared light reflected on the body 108. This allows for accurate detection of the plastic bottle 106.

However, as shown in FIG. 18, when the neck 107 of the plastic bottle 106 is located at the same height as or at almost the same height as the container detection sensor 71, the infrared light emitted from the light-emitting element is scattered due to reflection at the neck 107, as indicated by arrow Y in FIG. 18. Due to the scattering, the intensity of infrared light received by the light-receiving element decreases. This may lower the detection accuracy.

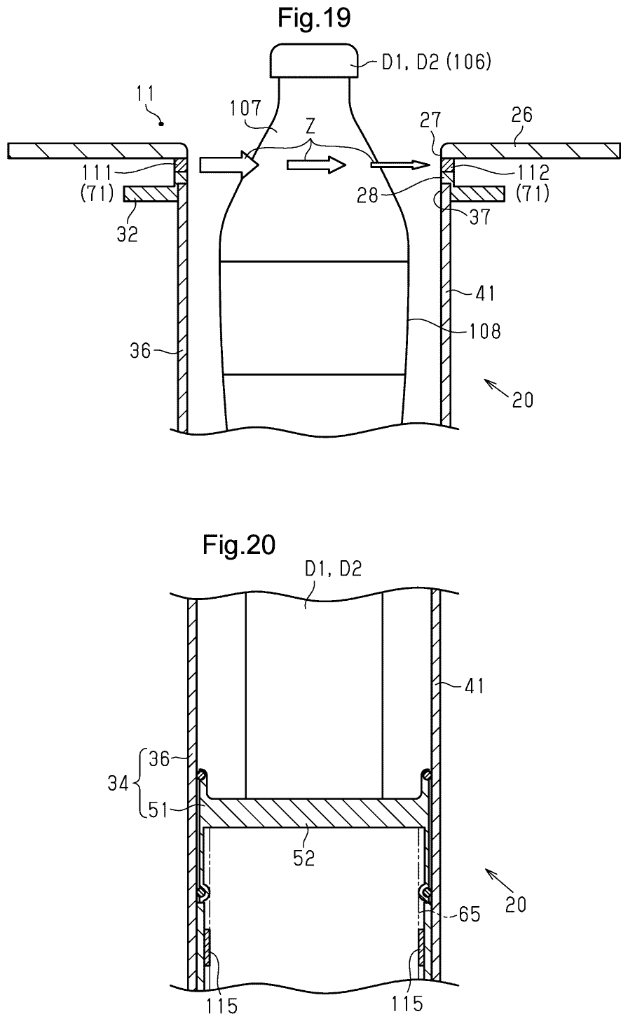

To solve this problem, as shown in FIG. 19, a transmissive IR sensor may be used as the container detection sensor 71. The transmissive IR sensor include a light-emitting element 111 and a light-receiving element 112 that are separate from each other. The light-emitting element 111 and the light-receiving element 112 are located in the tubular portion 28 at, for example, portions facing each other across the central axis of the side wall 36. The infrared light emitted by the light-emitting element 111 passes through the plastic bottle 106 (specifically, the neck 107) as indicated by arrow Z, and is subsequently received by the light-receiving element 112. The container detection sensor 71 detects the plastic bottle 106 based on the deviation (attenuation amount) between the amount of infrared light from the light-emitting element 111 and the amount of infrared light from the light-receiving element 112. In FIG. 19, the thickness of arrow Z represents the amount of infrared light that is transmitted. This allows infrared light to pass through and be received by the neck 107 of the plastic bottle 106 in the same manner as the body 108. As a result, the accuracy of detection at the neck 107 increases.

To detect the beverage container D1 or D2 being placed on the mounting portion 52 or 83, a sensor that is different from the IR sensor may be used as the container detection sensor. Such a sensor is, for example, a weight sensor.

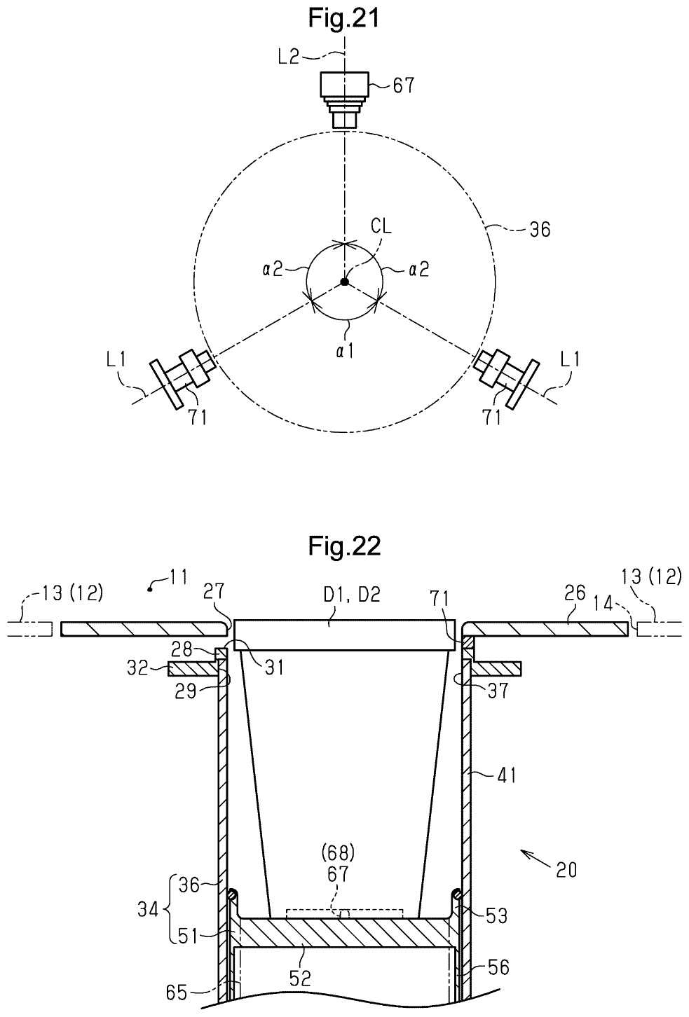

As shown in FIG. 21, the side wall 36 of the first embodiment has an axis extending in the vertical direction, referred to as the central axis CL, and an axis in each container detection sensor 71, referred to as the central axis L1.

In the first embodiment, the container detection sensor 71 is a reflective infrared sensor. In this configuration, there may be two container detection sensors 71 that are located between the side wall 36 and the top plate 26 and spaced apart from each other in the circumferential direction. Each container detection sensor 71 is arranged in an orientation facing the central axis CL. In this case, the beverage container D1 or D2 is detected based on the detection result of the two container detection sensors 71. As a result, the detection accuracy increases.

The angle formed between the axis L1 of one container detection sensor 71 and the axis L1 of the other container detection sensor 71 is referred to as angle α1.

In a reflective infrared sensor, generally, infrared light emitted by the light-emitting element is reflected from the front surface of an object to be detected within an angular range of 45°, and the reflected infrared light is received by the light-receiving element.

Thus, when angle α1 is less than 45°, the infrared light emitted from the light-emitting element of one container detection sensor 71 and reflected on the front surface of the beverage container D1 or D2 may be received by the light-receiving element of the other container detection sensor 71. Accordingly, the infrared light may be erroneously detected.

Further, if the two container detection sensors 71 may face each other (i.e., if angle α1 is set to 180° or approximately 180°), among the infrared lights emitted by the light-emitting element of one container detection sensor 71, the infrared light that has passed through the beverage container D1 or D2 may be received by the light-receiving element of the other container detection sensor 71, which faces the one container detection sensor 71. Accordingly, the infrared light may be erroneously detected.

Thus, to limit the above-described erroneous detection, angle α1 is preferably set to 45°≤α1≤150°.

As shown in FIG. 21, a contactless temperature sensor 67 may be used to detect temperature, and the temperature sensor 67 may be located at a position higher than that of the mounting portion 52. The temperature sensor 67 may be located, for example, at the same height as the container detection sensor 71 (i.e., between the side wall 36 and the top plate 26). When the beverage container D1 or D2 passes through the area in the direction in which the temperature sensor 67 is oriented as the bottom 51 moves up and down, the temperature sensor 67 detects the temperature of the beverage container D1 or D2.

In this case, the axis of the temperature sensor 67 is referred to as axis L2. The angle formed between axis L2 of the temperature sensor 67 and axis L1 of each container detection sensor 71 is referred to as angle α2. The temperature sensor 67 is arranged in an orientation facing the central axis CL.

As described above, when the two container detection sensors 71 and the temperature sensor 67 are located at the same height, these sensors may be arranged as follows.

As shown in FIG. 21, two angles α2 and one angle α1 may be set to the same value (120°). In other words, the temperature sensor 67 and the two container detection sensors 71 may be arranged at equal angular intervals around the central axis CL.

Instead, each angle α2 may be different from the angle α1, provided that 45°≤α1≤150°. In this case, each angle α2 may be set to the same value or may be a different value.

The container detection sensor and the temperature sensor of the cup holder 79 in the second embodiment may be changed in the same manner as the cup holder 20 of the first embodiment.

### Modifications of Indicator 73

The heating retention indicator 73a only has to emit light of a color that reminds the occupant that the beverage container D1 or D2 is warm. The color may be a warm tone that is different from yellow. The cooling retention indicator 73b only has to emit light of a color that reminds the occupant that the beverage container D1 or D2 is cold. The color may be a cool tone that is different from blue. The room temperature indicator 73c only has to emit light of a color that reminds the occupant that the beverage container D1 or D2 is neither warm nor cold. The color may be one that is neither a warm tone nor a cool tone and may be different from white.

The illuminance of the light emitted by each indicator 73 may be varied depending on the temperature T of the beverage container D1 or D2, which is detected by the temperature sensor 67.

The indicator 73 may be a full-color LED. The full-color LED contains individual monochrome LED chips for the three primary colors of light (i.e., red, blue, and green) within a single package. In the full-color LED, the intensity of light from each of the three LED chips (red, blue, and green) is adjusted by changing the current flowing through each chip. By altering the ratio of the three colors, the emitted color of the LED can be varied, even though it is a single LED.

If this modification is employed in the first embodiment, the emitted color (yellow, blue, or white) is switched according to the temperature T.

### Modifications of Ascent and Descent of Mounting Portion 52

In the first embodiment, as mentioned above, regardless of the height of the beverage container D1 or D2, the upper end portion is exposed to the outside from the upper surface of the cup holder 20 (top plate 26). This facilitates the removal of the beverage container D1 or D2.

Instead, the modification shown in FIG. 22 may be employed. In this modification, the raising of the lowered bottom 51 (mounting portion 52) is stopped at a time when the upper surface of the beverage container D1 or D2 reaches the same height as the upper surface of the cup holder 20 (top plate 26) or is slightly exposed from that surface. FIG. 22 illustrates a state in which the upper surface of the beverage container D1 or D2 is slightly exposed from the upper surface of the cup holder 20 (top plate 26). In this configuration, a larger area of the beverage container D1 or D2 is surrounded by the side heat insulator 41. As a result, the larger area of the beverage container D1 or D2 is kept warm or cool by the side heat insulator 41.

In this modification, a switch (not shown) used to remove the beverage container D1 or D2 may be added. When attempting to remove the beverage container D1 or D2, the occupant operates the switch to raise the bottom 51 (mounting portion 52) so that the beverage container D1 or D2 rises. This allows the user to remove the beverage container D1 or D2 from the accommodation portion 34 by pinching and gripping the raised beverage container D1 or D2.

For the cup holder 79 of the second embodiment, the time at which the raising of the lowered bottom 82 (mounting portion 83) is stopped may be changed in the same manner as the cup holder 20 of the first embodiment.

### Modifications of Accommodation Portion 121

In the third embodiment, the side wall 124 does not have to be cylindrical and may be polygonal.

In the third embodiment, the bottom 135 may include a bottom heat insulator 137. In the same manner as the side heat insulator 136, the bottom heat insulator 137 may be formed from a foamed resin material. This modification limits the transfer of heat in the bottom heat insulator 137 in the vertical direction, thereby keeping the beverage container D1 or D2 warm or cool. This is effective particularly when the mounting portion 143 comes into contact with the bottom 135 (i.e., when the spacer 140 is arranged in the second orientation within the side wall 124).

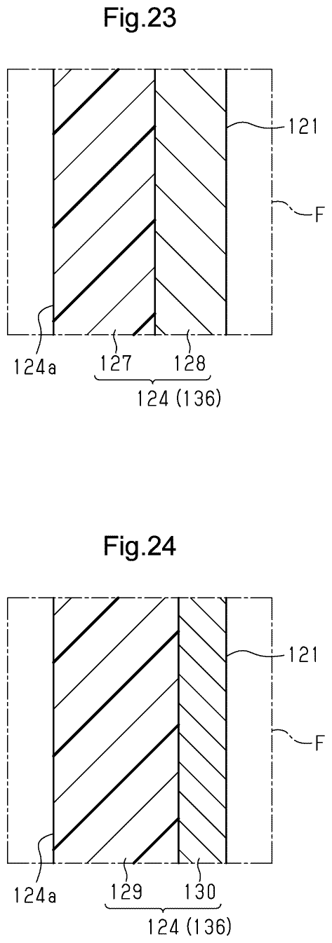

As shown in FIG. 23, the side heat insulator 136 of the third embodiment may include a tubular base 127, which is formed from a resin material, and a fiber heat insulator 128 laminated on the outer side (the right side in FIG. 23) of the base 127 in the thickness direction of the side wall 124. The lamination is performed, for example, by wrapping the fiber heat insulator 128 around the outer side of the base 127 in the thickness direction. The fiber heat insulator 128 is formed from a material (fiber insulating material), such as glass wool made from fiberglass formed into a cotton-like shape, with gaps between adjacent fibers.

In this modification, the side heat insulator 136 exerts a heat insulation effect using the gaps (air) between the fibers of the fiber heat insulator 128, thereby limiting heat conduction. Thus, in the side heat insulator 136, the gaps (air) between the fibers of the fiber heat insulator 128 limit the transfer of heat in the thickness direction of the side wall 124. As a result, temperature changes in the beverage container D1 or D2 and the beverage are limited (i.e., the beverage container D1 or D2 is kept warm or cool) for a relatively long period in the same manner as the first to third embodiments.

In the same manner as the side heat insulator 136 of FIG. 23, the bottom heat insulator 137 of the third embodiment may be formed by a laminate of the base 127 and the fiber heat insulator 128. This modification limits the transfer of heat in the bottom heat insulator 137 in the thickness direction of the mounting portion 143 (vertical direction), thereby keeping the beverage container D1 or D2 warm or cool.

As shown in FIG. 24, the side heat insulator 136 of the third embodiment may include a tubular base 129, which is formed from a resin material, and a heat shielding sheet 130 laminated on the outer side (the right side in FIG. 24) of the base 129 in the thickness direction of the side wall 124. The lamination is performed, for example, by wrapping the heat shielding sheet 130 around the outer side of the base 129 in the thickness direction. The heat shielding sheet 130 is a sheet-like component formed by coating a resin sheet, such as polyethylene, with a metal foil layer made from materials such as aluminum or silver.

In this modification, heat can be transferred through radiation. However, since the metal foil layer of the heat shielding sheet 130 reflects heat, thermal radiation is limited.

Thus, in the side heat insulator 136, the heat shielding sheet 130 limits the transfer of heat in the thickness direction of the side wall 124. As a result, temperature changes in the beverage container D1 or D2 and the beverage are limited (i.e., the beverage container D1 or D2 is kept warm or cool) for a relatively long period in the same manner as the first to third embodiments.

In the same manner as the side heat insulator 136 of FIG. 24, the bottom heat insulator 137 of the third embodiment may be formed by a laminate of the base 129 and the heat shielding sheet 130. This modification limits the transfer of heat in the bottom heat insulator 137 in the thickness direction of the mounting portion 143 (vertical direction), thereby keeping the beverage container D1 or D2 warm or cool.

In the same manner as the first embodiment (see FIG. 3), the side heat insulator 136 of the third embodiment may include multiple layers laminated in the thickness direction of the side wall 124 and have a layered structure that limits the transfer of heat in the thickness direction. The layers include an inner layer, an outer layer, a vacuum layer, and a metal foil layer.

In this case, in the same manner as the modification of the first embodiment, the metal foil layer may be laminated on the inner surface of the outer layer in the thickness direction of the side heat insulator 136, instead of or in addition to being laminated on the outer surface of the inner layer.

In the same manner as the modification of the first embodiment, instead of the metal foil layer, a plating layer formed from silver or the like may be formed on at least one of the outer surface of the inner layer and the inner surface of the outer layer in the thickness direction of the side wall 124.

The above-described modifications of the side heat insulator 136 (see FIGS. 23 and 24) in the third embodiment may also be employed in the bottom heat insulator 137 of the third embodiment.

Further, the above-described modifications may be employed in at least one of the side heat insulator 41 in the first embodiment and the side heat insulator 88 in the second embodiment, or may be employed in the bottom heat insulator 101 of the second embodiment.

### Modifications of Spacer 140

As a modification of the third embodiment, when a polygonal side wall 124 is used as described above, the leg 141 of the spacer 140 may be formed into the shape of a polygonal tube in correspondence with the side wall 124 and the mounting portion 143 may be formed into the shape of a polygonal plate.

The leg 141 may include leg segments, each extending in the vertical direction. These leg segments are arranged in the circumferential direction of the side wall 124 so as to collectively form a tubular shape.

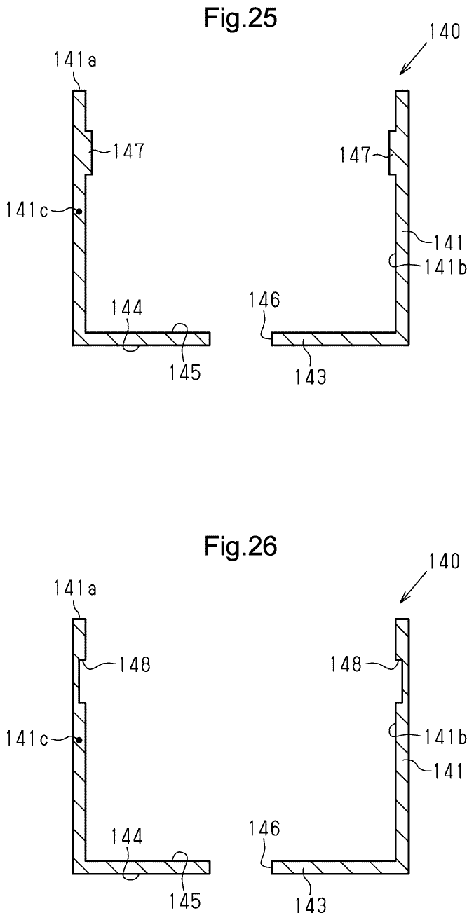

Instead of the second finger hook 142, the leg 141 may include a third finger hook 147 as shown in FIG. 25. The third finger hook 147 is a protrusion that protrudes inward from the inner side surface 141b in the thickness direction of the side wall 124. Alternatively, the leg 141 may include a third finger hook 148 as shown in FIG. 26. The third finger hook 148 is a recess that recesses outward from the inner side surface 141b of the leg 141 in the thickness direction. There may be one third finger hook 147 or one third finger hook 148. Alternatively, there may be multiple third finger hooks 147 or multiple third finger hooks 148.

These modifications allow the user of the cup holder 120 to hook the finger at the third finger hook 147, which is a protrusion, or the third finger hook 148, which is a recess. This allows the user to move the spacer 140 in the second orientation upward along the inner wall surface 124a of the side wall 124 by raising the finger hooked at the third finger hook 147 or 148. Such movement allows the spacer 140 to be removed from the side wall 124.

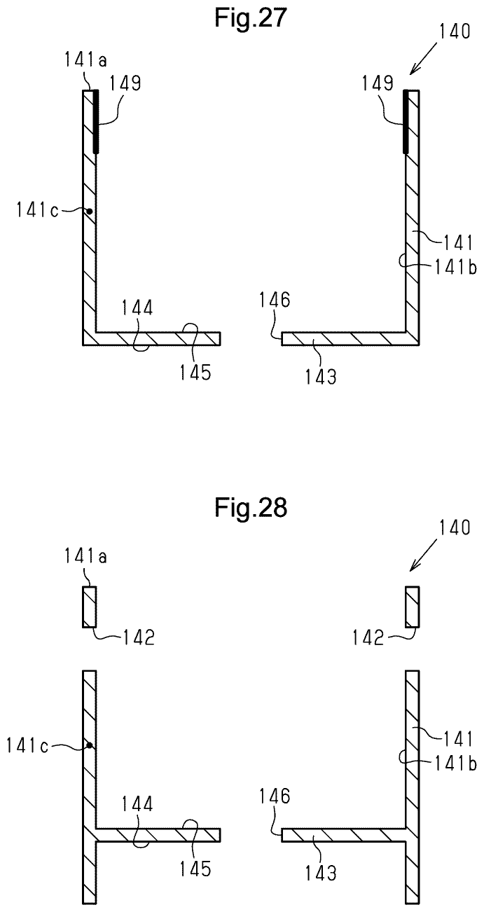

As shown in FIG. 27, part of the inner side surface 141b of the leg 141 in the thickness direction of the side wall 124 may be formed by a rough surface 149 that is rougher than the other parts of the inner side surface 141b. There may be one or more rough surfaces 149 in the inner side surface 141b. The rough surface 149 can be formed, for example, by applying a texturing process such as embossing to a portion of the inner side surface 141b.

In this modification, when the user of the cup holder 120 presses the finger on the rough surface 149, friction occurs between the finger and the surface. Thus, by raising their finger in this state, the user can move the spacer 140 in the second orientation upward along the inner wall surface 124a of the side wall 124. Such movement allows the spacer 140 to be removed from the side wall 124.

The leg 141 may be formed by a combination of two or more of the second finger hook 142, the third finger hook 147 or 148, and the rough surface 149. The number of the combinations is two at minimum and four at maximum.

As long as the mounting portion 143 of the spacer 140 is arranged at a position shifted from the middle part 141c toward one end of the leg 141 in the vertical direction, the mounting portion 143 may be located at a position that is different from the end. FIG. 28 illustrates an example where the mounting portion 143 is located at an intermediate portion between the middle part 141c of the leg 141 and the one end in the vertical direction.

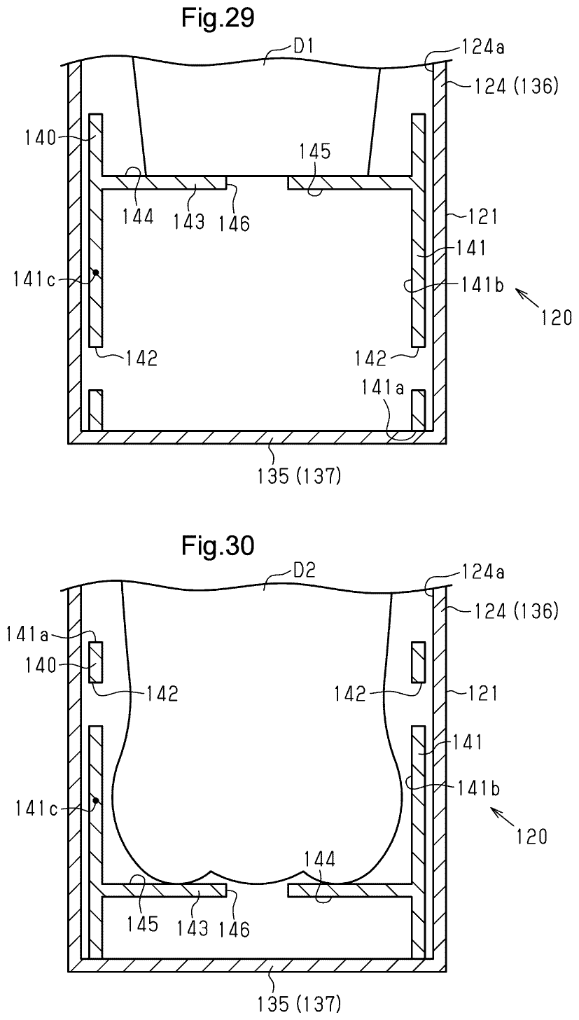

In this modification, as shown in FIG. 29, when the spacer 140 is arranged in the first orientation within the side wall 124, the mounting portion 143 is located at a position lower than that of the third embodiment (see FIG. 15), in which the mounting portion 143 is located at the one end (upper end portion) of the leg 141.

As shown in FIG. 30, when the spacer 140 is arranged in the second orientation within the side wall 124, the mounting portion 143 is located at a position higher than that of the third embodiment (see FIG. 16), in which the mounting portion 143 is located at the one end (lower end portion) of the leg 141.

Thus, this modification achieves the same operation and advantages as those of the third embodiment. The vertical position of the beverage container D1 or D2 accommodated in the accommodation portion 121 may be different from that in the third embodiment.

The leg 141 may be configured to extend and contract in the vertical direction.

The mounting portion 143 of the spacer 140 may have the same heat insulating structure as those of the bottom heat insulators 101 and 137.

The same applies to the leg 141 of the spacer 140. That is, the leg 141 may have the same heat insulating structure as those of the side heat insulators 41 and 136.

### Other Modifications

The depth of the mounting portion 52, 83, or 143 from the upper surface of the cup holder 20, 79, or 120 when the mounting portion 52, 83, or 143 is located at its lowest point and the spacer 140 is arranged in the second orientation may be set to be greater than the high-profile beverage container D2. This setting allows the entire beverage container D1 or D2 to be accommodated in the accommodation portion 34, 80, or 121. In this case, a lid may be provided to open and close the opening 27, 37, 86, 123, or 125. Instead, when the beverage container D1 or D2 is not accommodated in the accommodation portion 34, 80, or 121, a lid may be provided to open and close the opening 27, 37, 86, 123, or 125. In these modifications, when the opening 27, 37, 86, 123, or 125 is closed by the lid, the interior of the accommodation portion 34, 80, or 121 is hidden. Thus, as compared to when the opening 27, 37, 86, 123, or 125 is constantly open, the aesthetic appeal of the cup holder 20, 79, or 120 is improved.

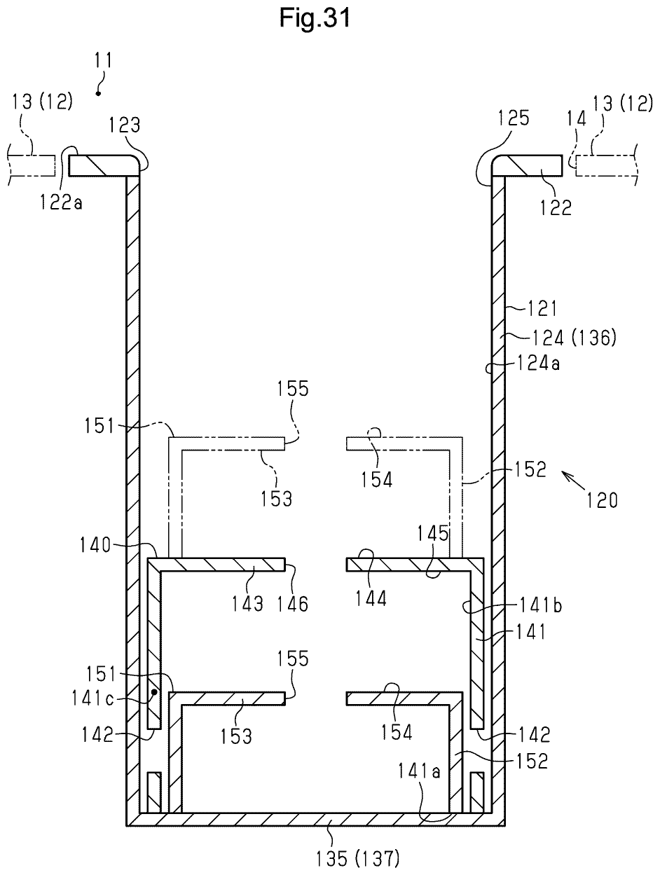

As shown in FIG. 31, in addition to the spacer 140 of the third embodiment, an auxiliary spacer 151 may be used. The auxiliary spacer 151 is used to adjust the vertical position of a beverage container accommodated in the accommodation portion 121 in cooperation with the spacer 140. The auxiliary spacer 151 is arranged in the side wall 124 in a removable manner.

The auxiliary spacer 151 is structured in the same manner as the spacer 140, and is smaller than the spacer 140. That is, the auxiliary spacer 151 includes an auxiliary leg 152 extending in the vertical direction, and an auxiliary mounting portion 153 provided at one end of the auxiliary leg 152 in the vertical direction. The auxiliary leg 152 has the shape of, for example, a cylinder that extends in the vertical direction. The outer diameter of the auxiliary leg 152 is set to be smaller than the inner diameter of the leg 141 of the spacer 140. The outer diameter of the auxiliary mounting portion 153 is set to be the same as or almost the same as the outer diameter of the auxiliary leg section 152.

The orientation in which the auxiliary spacer 151 is arranged relative to the side wall 124 includes an auxiliary first orientation. In the auxiliary first orientation, as shown in FIG. 31, the auxiliary mounting portion 153 is located at the upper end portion of the auxiliary leg 152.

The upper surface of the auxiliary mounting portion 153, when the auxiliary spacer 151 is arranged in the auxiliary first orientation, defines an auxiliary first mounting surface 154 on which a beverage container that is lower in height than the beverage container D1 is placed.

Further, the auxiliary mounting portion 153 includes an auxiliary first finger hook 155 that has a hole extending through the auxiliary mounting portion 153 in the vertical direction.

In this modification, when the beverage container D1 is placed on the first mounting surface 144 of the spacer 140 in the first orientation (see FIG. 15), the space enclosed by the leg 141 and the mounting portion 143 of the spacer 140 in the first orientation is used. In FIG. 31, as shown by the solid line, the auxiliary spacer 151 is accommodated in that space in the auxiliary first orientation. This eliminates the need for an additional portion that accommodates the auxiliary spacer 151.

As shown by the broken line in FIG. 31, the auxiliary spacer 151 oriented in the auxiliary first orientation may be placed on the first mounting surface 144 of the spacer 140 oriented in the first orientation. This allows the auxiliary first mounting surface 154 to be located at a height above the first mounting surface 144 by the height of the auxiliary spacer 151. The depth from the upper surface of the cup holder 20 on the auxiliary first mounting surface 154, where the beverage container is placed, is decreased by the thickness of the auxiliary spacer 151. In this manner, the height of the mounting surface where the beverage container is placed (i.e., the height of the bottom surface of the beverage container) can be readily increased using the auxiliary spacer 151.

The beverage container is inserted into the accommodation portion 121 through the openings 123 and 125 from above the cup holder 120 and placed on the auxiliary first mounting surface 154.

To remove, from the side wall 124, the auxiliary spacer 151 which is oriented in the auxiliary first orientation and on which no beverage container is placed, the user of the cup holder 120 inserts their finger into an auxiliary first finger hook 155 of the auxiliary mounting portion 153. This causes their finger to be locked on the auxiliary first finger hook 155. Thus, when the user raises their finger locked on the auxiliary first finger hook 155, the auxiliary spacer 151 moves upward together with their finger. Such movement allows the auxiliary spacer 151 to be removed from the side wall 124.

The additional auxiliary spacer used with the spacer 140 of the third embodiment may be not only the auxiliary spacer 151, which is shown in FIG. 31, but also a smaller spacer that is sized so as to be enclosed by the auxiliary spacer 151.

There may be one or more auxiliary spacers used in this modification. Multiple auxiliary spacers identical in shape may be used. Using the auxiliary spacer 151 shown in FIG. 31 as a reference, these spacers progressively decrease in size and are each covered by a larger spacer, forming a nested structure.

In the same manner as the first and second embodiments, the cup holder 120 of the third embodiment may include an indicator, a temperature sensor, and a controller. The temperature sensor detects the temperature of the beverage container D1 or D2 placed on the mounting portion 143. The controller causes the indicator to emit light of a color associated with the temperature detected by the temperature sensor.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle cup holder configured to be arranged in a passenger compartment of a vehicle and hold a beverage container, the vehicle cup holder comprising:
an accommodation portion including an upper end that has an opening, the accommodation portion being configured to accommodate at least a lower part of the beverage container, wherein
the accommodation portion includes:
a mounting portion configured such that the beverage container is placed on the mounting portion; and
a tubular side wall extending in a vertical direction, the side wall surrounding the beverage container when the beverage container is placed on the mounting portion,
a position of the mounting portion in the vertical direction is adjustable, and
a side heat insulator is arranged at least at a portion of the side wall that is higher than the mounting portion when the mounting portion is located at a lowest point, the side heat insulator limiting transfer of heat in a thickness direction of the side wall.

2. The vehicle cup holder according to claim 1, wherein
the side heat insulator includes multiple layers laminated in the thickness direction of the side wall and has a layered structure, the layered structure limiting transfer of heat in the thickness direction.

3. The vehicle cup holder according to claim 1, wherein
the mounting portion includes a bottom heat insulator that limits transfer of heat in the vertical direction, the vertical direction corresponding to a thickness direction of the mounting portion.

4. The vehicle cup holder according to claim 3, wherein
the bottom heat insulator includes multiple layers laminated in the vertical direction and has a layered structure, the layered structure limiting transfer of heat in the vertical direction.

5. The vehicle cup holder according to claim 2, wherein
the layered structure includes:
an inner layer;
an outer layer located outward from the inner layer in the thickness direction;
a vacuum layer between the inner layer and the outer layer; and
a metal foil layer between the inner layer and the outer layer.

6. The vehicle cup holder according to claim 4, wherein
the layered structure includes:
an inner layer;
an outer layer located outward from the inner layer in the thickness direction;
a vacuum layer between the inner layer and the outer layer; and
a metal foil layer between the inner layer and the outer layer.

7. The vehicle cup holder according to claim 1, wherein
the side heat insulator is formed from a foamed resin material.

8. The vehicle cup holder according to claim 1, wherein
the side heat insulator includes:
a tubular base formed from a resin material; and
a fiber insulator formed from a fiber insulating material that has gaps between adjacent ones of fibers, the fiber insulator being laminated on an outer side of the base in the thickness direction.

9. The vehicle cup holder according to claim 1, wherein
the side heat insulator includes:
a tubular base formed from a resin material; and
a heat shielding sheet laminated on an outer side of the base in the thickness direction.

10. The vehicle cup holder according to claim 1, wherein
the mounting portion is movable up and down, and
a position of the mounting portion in the vertical direction is adjusted by moving up or down the mounting portion.

11. The vehicle cup holder according to claim 10, wherein
the side wall includes:
a tubular fixed side wall portion extending in the vertical direction, wherein an upper end of the fixed side wall portion has the opening; and
a tubular movable side wall portion extending in the vertical direction, wherein an upper end of the movable side wall portion is open,
the fixed side wall portion includes an annular accommodation portion having an open lower end and extending in the vertical direction, the annular accommodation portion being located at an intermediate part of the fixed side wall portion in the thickness direction,
the fixed side wall portion has part of the side heat insulator located inward from the annular accommodation portion in the thickness direction,
the movable side wall portion has part of the side heat insulator,
the movable side wall portion is fixed to a peripheral edge of the mounting portion, wherein the movable side wall portion moves up and down in the annular accommodation portion as the mounting portion moves up and down,
the side heat insulator of the fixed side wall portion is arranged on the entirety of a section of the fixed side wall portion in the vertical direction, the section being located inward from the annular accommodation portion in the thickness direction, and
the side heat insulator of the movable side wall portion is arranged at least at a position of the movable side wall portion that is higher than the mounting portion.

12. The vehicle cup holder according to claim 10, further comprising:
a lift mechanism configured to raise and lower the mounting portion;
an actuator configured to activate the lift mechanism;
a container detection sensor configured to detect the beverage container; and
circuitry configured to control the actuator based on a detection result of the container detection sensor, and
the circuitry is configured to control the actuator such that:
the mounting portion is lowered upon detection of the beverage container that is performed by the container detection sensor;
the mounting portion stops being lowered when the beverage container is no longer detected; and
the mounting portion is then raised to a constant height.

13. The vehicle cup holder according to claim 10, wherein
the mounting portion forms part of a bottom of the accommodation portion, and the bottom includes:
an annular upper protrusion that protrudes upward from a peripheral edge of the mounting portion; and
an annular upper seal member attached to an outer circumference of the upper protrusion to seal between the upper protrusion and the side wall.

14. The vehicle cup holder according to claim 13, wherein
the bottom includes:
an annular lower protrusion extending downward from the peripheral edge of the mounting portion; and
an annular lower seal member attached to an outer circumference of the lower protrusion to seal between the lower protrusion and the side wall.

15. The vehicle cup holder according to claim 14, wherein
the side wall has a shape of a tube that includes an open upper end portion and an open lower end portion, and
the bottom is inserted into the side wall in a removable manner.

16. The vehicle cup holder according to claim 14, wherein
the upper seal member and the lower seal member are formed from an elastic material.

17. The vehicle cup holder according to claim 1, wherein
an upper end portion of the side wall is open,
the vehicle cup holder further comprises a spacer arranged in the side wall in a removable manner, the spacer being configured to adjust a position of, in the vertical direction, the beverage container that is accommodated in the accommodation portion,
the spacer includes:
a leg extending in the vertical direction; and
a mounting portion arranged at a portion shifted toward one end of the spacer from a middle part of the leg in the vertical direction,
the mounting portion of the spacer forms the mounting portion of the accommodation portion,
an orientation of the spacer located in the side wall includes:
a first orientation in which the mounting portion is located above the middle part of the leg; and
a second orientation in which the mounting portion is located below the middle part of the leg,
the mounting portion includes:
a first mounting surface configured such that the beverage container is placed on the first mounting surface when the spacer is oriented in the first orientation; and
a second mounting surface configured such that the beverage container is placed on the second mounting surface when the spacer is oriented in the second orientation, and
a position of the mounting portion in the vertical direction is adjusted by switching the orientation of the spacer.

18. The vehicle cup holder according to claim 1, further comprising:
an indicator;
a temperature sensor configured to detect a temperature of the beverage container placed on the mounting portion; and
circuitry configured to cause the indicator to emit light of a color associated with the temperature detected by the temperature sensor.

19. The vehicle cup holder according to claim 18, wherein
the temperature sensor is incorporated in the mounting portion, and
the temperature sensor includes a detector that is biased upward, wherein the temperature sensor is configured to detect the temperature of the beverage container by bringing the detector into contact with a bottom surface of the beverage container placed on the mounting portion.
